(19) United States
(12) Patent Application Publication
(10) Pub. No.: US 2025/0379619 A1
(43) Pub. Date: Dec. 11, 2025

(54) INTEGRATED SENSING AND COMMUNICATION WITH MILLIMETER WAVE FULL DUPLEX HYBRID BEAMFORMING

(71) Applicant: THE BOARD OF TRUSTEES OF THE UNIVERSITY OF ILLINOIS, URBANA, IL (US)

(72) Inventors: Besma Smida, Chicago, IL (US); MD Atiqul Islam, Chicago, IL (US); Georgios Alexandropoulos, Athens (GR)

(73) Assignee: THE BOARD OF TRUSTEES OF THE UNIVERSITY OF ILLINOIS, URBANA, IL (US)

(21) Appl. No.: 19/114,047

(22) PCT Filed: Sep. 22, 2023
(86) PCT No.: PCT/US2023/074832

§ 371 Date: Mar. 21, 2025

Related U.S. Application Data
(60) Provisional application No. 63/408,880, filed on Sep. 22, 2022.

(51) Int. Cl. H04B 7/0452; H04B 7/0456; H04L 5/14

(52) U.S. Cl. CPC H04B 7/0452; H04B 7/0456; H04L 5/14

(57) ABSTRACT

The disclosure provides an example Full Duplex-based ISAC optimization system. The system includes: (a) a Full Duplex (FD) massive MIMO Base Station (BS) node configured to operate at mmWave frequencies and having a plurality of transmitter antenna elements and a plurality of receiver antenna elements configured to communicate in a DownLink (DL) direction with a plurality of mobile users that each have a plurality of antenna receiver elements, where the plurality of RX antenna elements of the FD massive MIMO BS node are configured to receive DL signals reflected by a plurality of radar targets, and (b) at least one processor detects the plurality of radar targets randomly distributed within a communication environment based on the reflected DL signals, where the processor determines an estimation of a Direction of Arrival (DoA), a range, and a relative velocity for radar targets while optimizing a DL communication rate to the mobile users.

### CROSS REFERENCE TO RELATED APPLICATION

This application is an International PCT Application that claims priority to U.S. Provisional Application No. 63/408,880, filed on Sep. 22, 2022, that is hereby incorporated by reference in its entirety.

### STATEMENT OF GOVERNMENTAL INTEREST

This invention was made with government support under grant number 1620902 from the National Science Foundation. The government has certain rights in this invention.

### BACKGROUND

To maximize the performance of FD ISAC systems, a cooperative design of the A/D beamformers and Self Interference (SI) cancellation, as well as sensing approaches, is necessary. When using the FD ISAC operation for mmWave frequency bands with a large MIMO FD Base Station (BS), the signal power in the radar target direction is maximized while maintaining a threshold DL rate performance. Because of its disassociated DoA and range estimation technique, it only calculates the range for one of the two radar targets. System configured to provide range estimates for more than two targets that are needed to enable sufficient radar target sensing for future systems are currently unavailable.

### SUMMARY

In a first aspect of the disclosure, an example full duplex-based ISAC optimization system. The FD-based ISAC optimization system includes (a) a Full Duplex (FD) massive Multiple-input and Multiple-output (MIMO) Base Station (BS) node configured to operate at mmWave frequencies and having a plurality of transmitter antenna elements (N_{A} TX) and a plurality of receiver antenna elements (M_{A} RX) configured to communicate in a DownLink (DL) direction with a plurality of mobile users that each have a plurality of antenna receiver elements (L), where the plurality of RX antenna elements of the FD massive MIMO BS node are configured to receive DL signals reflected by a plurality of radar targets; and (b) at least one processor configured to detect the plurality of radar targets randomly distributed within a communication environment based on the plurality of reflected DL signals, where the at least one processor is further configured to determine an estimation of (i) a Direction of Arrival (DoA), (ii) a range, and (iii) a relative velocity for each of the plurality of radar targets while optimizing a DL communication rate to the plurality of mobile users.

In a second aspect of the disclosure, an example method for using the FD-based ISAC optimization system according to the first aspect of the disclosure is provided. The method includes (a) transmitting, via the plurality of TX antenna elements of the FD massive MIMO BS node, mmWave Orthogonal Frequency Division Multiplexing (OFDM) waveforms in the DL direction to the plurality of mobile users, (b) receiving, via the plurality of RX antenna elements of the FD massive MIMO BS node, DL signals reflected by the plurality of radar targets, and (c) estimating, via the processor, the DoA, the range, and the relative velocity for each of the DL signals reflected by the plurality of radar targets, where the transmitted mmWave OFDM waveform is used for both DL data transmission and for sensing of the plurality of the radar targets via the estimations for the DoA, the range, and the relative velocity of the plurality of radar targets.

The features, functions, and advantages that have been discussed can be achieved independently in various examples or may be combined in yet other examples further details of which can be seen with reference to the following description and drawings.

### BRIEF DESCRIPTION OF THE DRAWINGS

FIG. 1 depicts the considered FD-enabled massive MIMO ISAC system, where the FD hybrid A/D beamforming BS communicates with DL users and simultaneously detects corresponding DoA and range of radar targets, according to an example implementation;

FIG. 2A depicts the Proposed FD-enabled ISAC scheme, according to an example implementation;

FIG. 2B depicts the conventional HD-based ISAC signaling in each time subframe, according to an example implementation;

FIG. 3 depicts the DoA and range estimation performance of the proposed FD ISAC system for four (4) radar targets with N_{BF}=M_{BF}=8, N_{A}=N_{A}=16 and DL transmit power of 30 dBm, according to an example implementation;

FIG. 4 depicts the DoA Tracking performance for four (4) radar targets with N_{BF}=M_{BF}=8, N_{A}=N_{A}=16 and DL transmit power of 30dBm, according to an example implementation;

FIG. 5 depicts the Multi-user DL rate with respect to transmit power in dBm for the 128×128 massive MIMO FD BS communicating with U=2 DL users, according to an example implementation;

FIG. 6 depicts the considered FD massive MIMO ISAC system: the FD hybrid A/D beamforming Base Station (BS) communicates in the downlink with a mobile single-antenna half-duplex User Equipment (UE), while its reflected transmitted signals from radar targets/scatters in the environment are received via hybrid combining and processed for DoA, range, and relative velocity estimations of the radar targets/scatters, according to an example implementation;

FIG. 7A depicts DoA and range estimation based on sensing parameter estimation performance for six (6) radar targets with

$${N}_{b}^{RF} = {M}_{b}^{RF} = 8 , {N}_{b}^{A} = {N}_{b}^{A} = 16$$

and transmit power of 30 dBm, according to an example implementation;

FIG. 7B depicts range and relative velocity estimation based on sensing parameter estimation performance for six (6) radar targets with

$${N}_{b}^{RF} = {M}_{b}^{RF} = 8 , {N}_{b}^{A} = {N}_{b}^{A} = 16$$

and transmit power of 30 dBm, according to an example implementation

FIG. 8A depicts DoA and range estimation based on sensing parameter estimation performance for six (6) radar targets with

$${N}_{b}^{RF} = {M}_{b}^{RF} = 8 , {N}_{b}^{A} = {N}_{b}^{A} = 16$$

and DL transmit power of 10 dBm, according to an example implementation;

FIG. 8B depicts Range and relative velocity estimation DoA and range estimation based on sensing parameter estimation performance for six (6) radar targets with

$${N}_{b}^{RF} = {M}_{b}^{RF} = 8 , {N}_{b}^{A} = {N}_{b}^{A} = 16$$

and DL transmit power of 10 dBm, according to an example implementation;

FIG. 9 depicts DL rate with respect to transmit power in dBm for the 128×128 massive MIMO FD BS communicating with a four (4) antenna UE RX node, according to an example implementation; and

FIG. 10 depicts a flowchart of a method for using the FD-based ISAC optimization system, according to an example implementation;.

The drawings are for the purpose of illustrating examples, but it is understood that the disclosure is not limited to the arrangements and instrumentalities shown in the drawings.

### DETAILED DESCRIPTION

In accordance with the principles of the present disclosure a Full Duplex (FD)-based Integrated Sensing and Communication (ISAC) system operating at millimeter Wave (mmWave) frequencies, which is capable of simultaneous radar target sensing and DownLink (DL) data transmission is set forth. The ISAC system advantageously permits the simultaneous transmission and reception capability of the FD technology and can perform high-resolution long-range parameter estimation of multiple radar targets while maximizing the DL data rate.

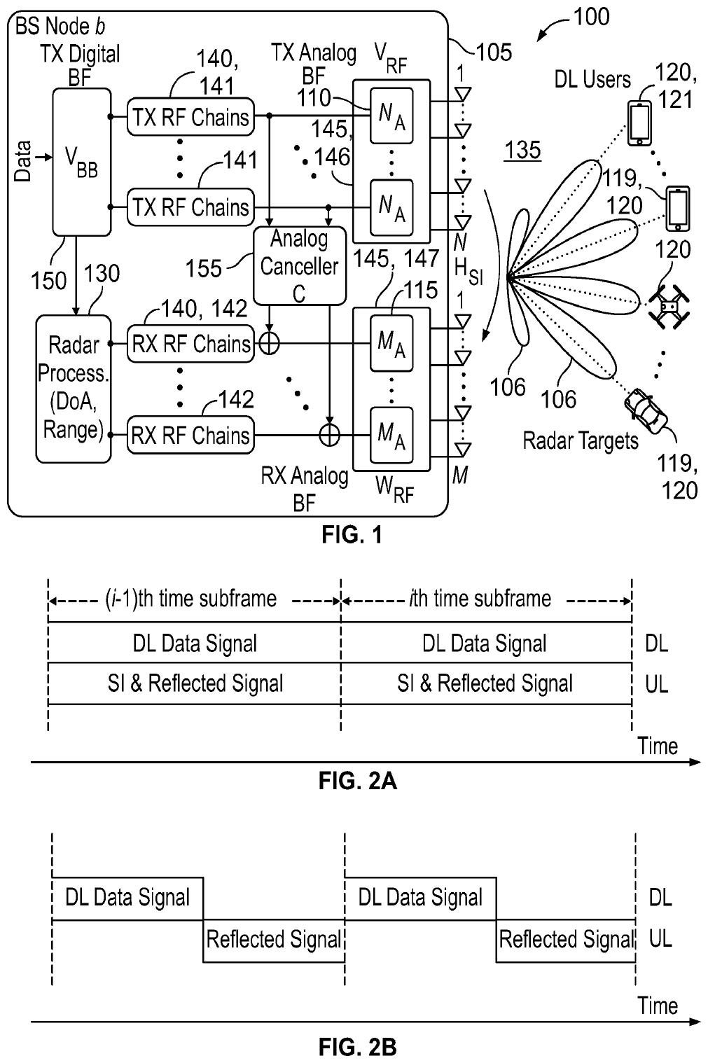

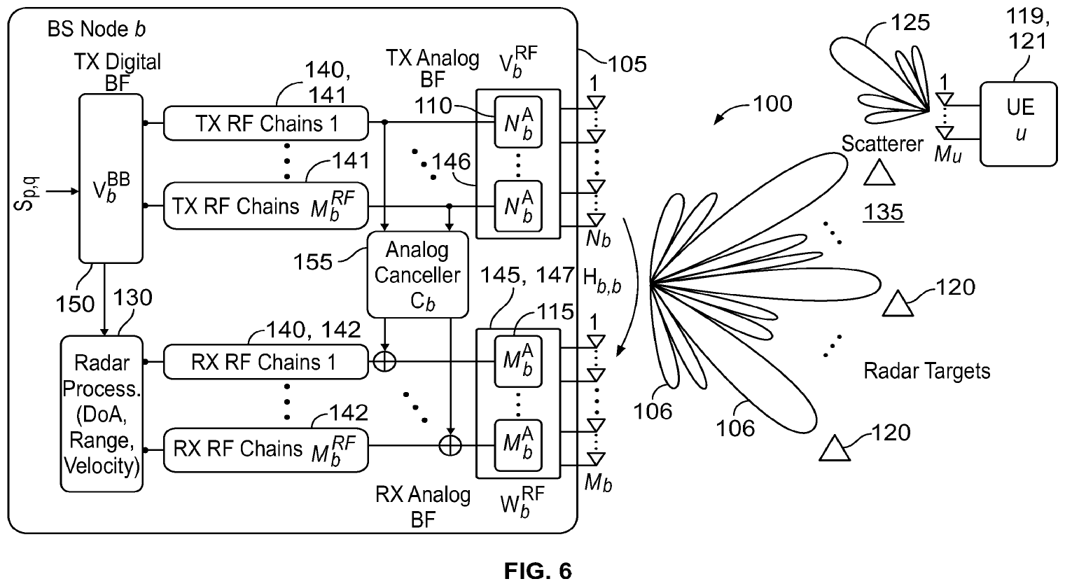

As shown in FIGS. 1 and 6, a Full Duplex-based ISAC optimization system 100 includes a Full Duplex (FD) massive Multiple-input and Multiple-output (MIMO) Base Station (BS) node 105 configured to operate at mm Wave frequencies and having a plurality of transmitter antenna elements (N_{A} TX) 110 and a plurality of receiver antenna elements (M_{A} RX) 115 configured to communicate in a DownLink (DL) direction with a plurality of mobile users 119 that each have a plurality of antenna receiver elements 121. The plurality of RX antenna elements 115 of the FD massive MIMO BS node 105 are configured to receive DL signals 125 reflected by the plurality of radar targets 120.

The FD-based ISAC optimization system 100 also includes at least one processor 130 configured to detect the plurality of radar targets 120 randomly distributed within a communication environment 135 based on the plurality of reflected DL signals 125. The at least one processor 130 is further configured to determine an estimation of (i) a Direction of Arrival (DoA), (ii) a range, and (iii) a relative velocity for each of the plurality of radar targets 120 while optimizing a DL communication rate to the plurality of mobile users 119.

According to one optional implementation, the FD massive MIMO BS node 105 is configured to transmit mmWave Orthogonal Frequency Division Multiplexing (OFDM) waveforms 106 in the DL direction containing Q OFDM symbols with P active subcarriers.

According to one optional implementation, the FD-based ISAC optimization system 100 includes a hybrid beam-forming structure (HBF) 140 that includes a plurality of TX radio-frequency (RF) chains 141 and a plurality of RX RF chains 142 that are operatively connected to uniform linear arrays (ULAs) of the plurality of antenna elements N_{A} TX 110 and M_{A} RX 115 via analog phase shifters 145 that are contained in analog beamformers V_{RF} 146 and W_{RF} 147, respectively.

According to one optional implementation, the FD-based ISAC optimization system 100 includes a digital beamforming matrix V_{BB} 150 operatively connected to the analog beamformer V_{RF} 146 and the processor 135. The digital beam forming matrix V_{BB} 150 is configured to precode a unit power frequency-domain symbol vector at a pth subcarrier of a qth OFDM symbol in a BaseBand (BB).

According to one optional implementation, the FD-based ISAC optimization system 100 includes at least one Self-Interference (SI) canceller 155 operatively connected to the HBF configured for both analog and digital cancellation.

According to one optional implementation, the FD-based ISAC optimization system 100 includes a DL channel dedicated to data transmission to the plurality of mobile users 119 and an UpLink (UL) channel configured to simultaneously receive the reflected DL signals from the plurality of radar targets 120.

According to one optional implementation, the FD massive MIMO BS node 105 and the processor are coupled to an In-Communication 5G BS, an In-Communication 6G BS, a UAV, or an Autonomous Vehicle.

The following method 200 may include one or more operations, functions, or actions as illustrated by one or more of blocks 205-215. Although the blocks are illustrated in a sequential order, these blocks may also be performed in parallel, and/or in a different order than those described herein. Also, the various blocks may be combined into fewer blocks, divided into additional blocks, and/or removed based upon the desired implementation. Alternative implementations are included within the scope of the examples of the present disclosure in which functions may be executed out of order from that shown or discussed, including substantially concurrent or in reverse order, depending on the functionality involved, as would be understood by those reasonably skilled in the art.

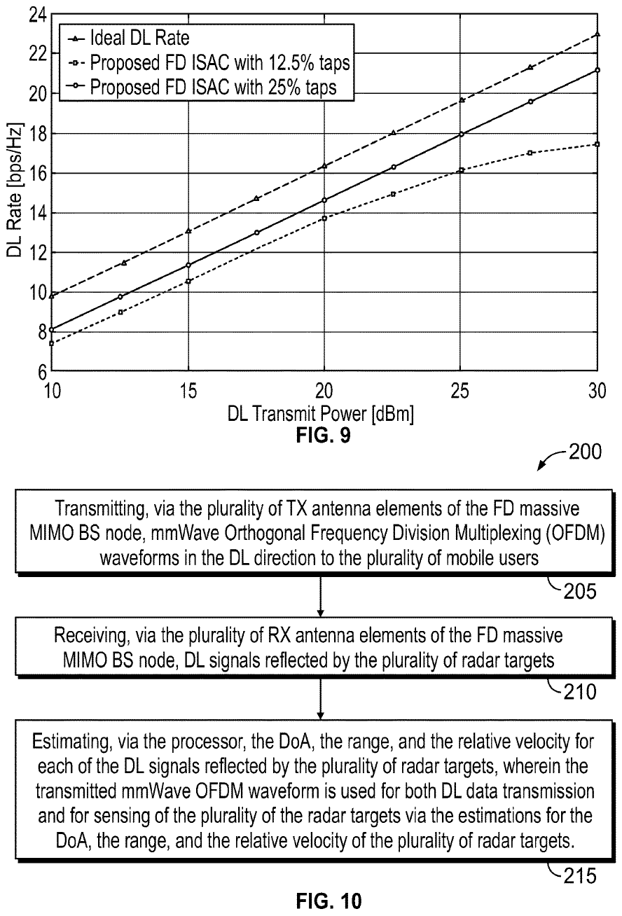

Referring now to FIG. 10, FIG. 10 shows a flowchart of an example method 200 for using the FD-based ISAC optimization system 100, according to an example implementation. Method 200 includes, at block 205, transmitting, via the plurality of TX antenna elements 110 of the FD massive MIMO BS node 105, mmWave Orthogonal Frequency Division Multiplexing (OFDM) waveforms 106 in the DL direction to the plurality of mobile users 119. Then, at block 210, the plurality of RX antenna elements 115 of the FD massive MIMO BS node 105 receive DL signals 125 reflected by the plurality of radar targets 120. Next, at block 215, the processor 130 estimates the DoA, the range, and the relative velocity for each of the DL signals 106 reflected by the plurality of radar targets 120. The transmitted mmWave OFDM waveform 106 is used for both DL data transmission and for sensing of the plurality of the radar targets via the estimations for the DoA, the range, and the relative velocity of the plurality of radar targets 120.

According to one optional implementation, the mmWave OFDM waveforms contain Q OFDM symbols with P active subcarriers. Method 200 further includes, before transmitting the mmWave OFDM waveforms 106 in the DL direction to the plurality of radar targets 120, precoding, via digital beamforming matrix V_{BB}, a unit power frequency-domain symbol vector at a pth subcarrier of a qth OFDM symbol in a DL signal. Then, after precoding the unit power frequency-domain symbol vector, an analog beamformer V_{RF} 146 processing the DL signal.

According to one optional implementation, after the reflected DL signals 125 are received, method 200 includes processing the reflected DL signals 125, via an analog beamformer W_{RF} 147, to achieve RF combination. Then, at least one SI canceller 155 performs analog and digital Self-Interference (SI) cancellation on the reflected DL signals 125 to thereby suppress the Line-of-Sight (LoS) SI signal below a noise floor.

According to one optional implementation, after the analog SI cancellation, a residual SI signal satisfies an RX RF saturation constraint.

According to one optional implementation, transmitting the mmWave OFDM waveforms 106 in the DL direction to the plurality of mobile users 119 occurs in subframes of Tₛ duration.

According to one optional implementation, after SI cancellation is performed on the received signals, estimating the DoA and the range for each of the DL signals 125 reflected by the plurality of radar targets 120 is performed at an (i-1)th time subframe. Method 200 further includes, during DL data transmission to the plurality of radar targets 120 at an ith time subframe, determining, via the processor 130, an appropriate digital beam former V_{BB}[i], a TX phase shifter configuration V_{RF}[i], and an RX phase shifter configuration W_{RF}[i] based on the estimated DoAs for each of the plurality of radar targets.

According to one optional implementation, determining, via the processor 130, the appropriate digital beam former V_{BB}[i], the TX phase shifter configuration V_{RF}[i], and the RX phase shifter configuration W_{RF}[i] is further determined to maximize signal power toward all radar directions and to minimize SI channel impact at the plurality of RX antenna elements 115 of the FD massive MIMO BS node 105.

According to one optional implementation, the plurality of radar targets 120 are tracked across the subframes.

According to one optional implementation, a digital beamforming matrix V_{BB} 150 is configured using block diagonalization to maximize the Signal-to-Noise-Ratio of the plurality of radar targets 120, to minimize interference between the plurality of radar targets 120, and to suppress a residual SI at the FD massive MIMO BS node 105.

According to one optional implementation, method 200 includes the processor 130 maximizing the Signal-to-Noise-Ratio for transmitted signals in both the DL direction and a radar target direction.

According to one optional implementation, transmitting mmWave OFDM waveforms 106 in the DL direction to the plurality of mobile users 119 is conducted with a transmission power ranging from 10 dBm to 30 dBm. According to one optional implementation, wherein the mm Wave OFDM waveforms are 5G OFDM waveforms.

According to one optional implementation, method 200 further includes generating, via the processor 130, a vehicular side link based on the estimated range of one of the plurality of radar targets 120. Then, at least one of the plurality of TX antenna elements 110 of the FD massive MIMO BS node 105 transmits the vehicular side link to the particular radar target 120 that corresponds to the subject estimated range.

In certain implementations, a sensing algorithm capable of estimating Direction of Arrival (DoA), range, and relative velocity of the radar targets can be stored in the processor 130 operatively connected to the system 100.

Systems and embodiments contemplated herein can be utilized to develop Integrated Sensing and communication devices in Autonomous vehicles, Unmanned Aerial Vehicles (UAVs), communication base stations, etc. The present disclosure provides the framework for high-resolution, long-range radar sensor for autonomous vehicles while simultaneously vehicle-to-vehicle, vehicle-to-BS, or vehicle-to-user data transmission in mmWave frequencies using, for example, 5G waveforms. The discovery can develop smart ISAC infrastructure for high-speed autonomous vehicles providing a seamless communication and radar sensing performance.

In some embodiments, systems and devices constructed in accordance with the principles herein can be applied to vehicular sidelink—communication and sensing for vehicular networks, if desired.

### EXAMPLE 1

### Simultaneous Multi-User MIMO Communications and Multi-Target Tracking With Full Duplex Radios

An Integrated Sensing and Communications (ISAC) system enabled by in-band Full Duplex (FD) radios is disclosed, where a massive Multiple-Input Multiple-Output (MIMO) base station equipped with hybrid Analog and Digital (A/D) beamformers is communicating with multiple DownLink (DL) users, and simultaneously estimates via the same signaling waveforms the Direction of Arrival (DoA) as well as the range of radar targets randomly distributed within its coverage area. Capitalizing on a recent reduced-complexity FD hybrid A/D beamforming architecture, a joint radar target tracking and DL data transmission protocol was devised. An optimization framework for the joint design of the massive A/D beamformers and the Self-Interference (SI) cancellation unit, with the dual objective of maximizing the radar tracking accuracy and DL communication performance, is disclosed. The simulation results at millimeter wave frequencies using 5G NR wideband waveforms, showcase the accuracy of the radar target tracking performance of the proposed system, which simultaneously offers increased sum rate compared with benchmark schemes.

### I. Introduction

Integrated Sensing and Communications (ISAC) is emerging as a key feature of the next-generation wireless networks, where sensing and communication signaling operations are unified in a single system to considerably improve spectral and energy efficiencies while reducing both hardware and signaling costs. In addition to its implementation in cellular net-works, ISAC systems have recently been considered for a wide variety of applications, e.g., Wi-Fi networks, Unmanned Aerial Vehicle (UAV) networks, military communications, and localization for Vehicular networks (V2X). As a key enabler for ISAC applications, Full Duplex (FD) massive Multiple-Input Multiple-Output (MIMO) radios have the potential to be employed for the simultaneous DownLink (DL) transmission and UpLink (UL) reception capability within the entire frequency band. FD multi-user massive MIMO systems in conjunction with fifth Generation (5G) millimeter Wave (mmWave) wideband waveforms can provide high-resolution radar target detection and tracking while ensuring high-capacity communication links to DL users.

The principal bottleneck of the FD ISAC systems is the Self-Interference (SI) signal induced from the Transmitter (TX) to the Receiver (RX) at the massive MIMO FD Base Station (BS) node due to FD operation. Recently, a combination of propagation domain isolation, analog domain suppression, and digital SI cancellation techniques has been employed to achieve the required SI suppression for the mmWave FD massive MIMO transceivers. Hybrid Analog and Digital (A/D) BeamForming (HBF) is an attractive configuration for FD massive MIMO systems since it utilizes a small number of Radio Frequency (RF) chains connected to large-scale antenna arrays via phase shifters to reduce hardware cost. Appropriate A/D beamforming in the FD HBF system can reduce the impact of SI in the FD RX chains. Thus, a reduced complexity A/D SI cancellation solution can be formulated for FD massive MIMO systems with hybrid beamforming.

Recently, single-antenna FD systems employing joint radar communication and sensing were introduced, where both communication and radar waveforms were studied for sensing performance. FD ISAC operations with mmWave massive MIMO systems were also proposed. A multibeam approach with dedicated beams towards both a radar target and a DL user has been considered by others, whereas other researchers provided an ISAC technique detecting the Direction of Arrival (DoA) of two radar targets, while only successfully estimating the range of one target. In Example 2 of the present disclosure, a reduced complexity single-user FD ISAC system was proposed with massive MIMO BS operating at mmWave frequencies capable of estimating both the DoA and range of multiple radar targets, while maximizing the DL rate. However, none of the previous works provide an FD ISAC massive MIMO system with radar target tracking protocols across multiple communication slots with simultaneous multi-user DL communication.

In the present Example, a multi-user FD ISAC system is disclosed including a protocol for multiple radar target DoA tracking and range estimation across several communication subframes. The considered ISAC system employs an FD massive MIMO BS node communicating with multiple DL users, and utilizes the reflected waveforms to detect and track the radar targets residing within the communication environment. A joint design is proposed of the A/D beamformers and a reduced complexity SI cancellation for the FD ISAC system, which target at maximizing the multi-user DL communication rate and the precision of the radar target tracking. An extensive waveform simulation is performed with 5G wideband Orthogonal Frequency Division Multiplexing (OFDM) waveforms at mm Wave frequencies, verifying the performance of the proposed multi-user FD ISAC system.

### II. System and Signal Models

A multi-user FD massive MIMO ISAC system is considered operating at mmWave frequencies, where an FD massive MIMO BS node is communicating with U RX user nodes in the DL direction, as depicted in FIG. 1. The DL signals are reflected by the multiple radar targets distributed within the communication environment, which are received and processed at the RX of BS node for radar targets' parameter estimation enabling integrated sensing and communication.

The FD massive MIMO BS node b is comprised of N TX and M RX antennas, whereas each of the U users has LRX antennas. To reduce the hardware complexity in massive MIMO BS node, we consider a small number of TX/RX RF chains partially-connected to Uniform Linear Arrays (ULAs) of large number of antenna elements via analog phase shifters following a Hybrid BeamForming (HBF) structure. Therefore, in the BS node, each of the N_{RF} and M_{RF} TX/RX RF chains are connected to ULAs of N_{A} and M_{A} antenna elements, respectively. The configurations of the phase shifters are contained analog beamformers [symbol] [symbol] [symbol] , and [symbol] [symbol] [symbol] , respectively. The elements of the TX/RX analog BFs are assumed to have constant magnitude and chosen from predefined beam codebooks, i.e., [symbol] [symbol] [symbol] and [symbol] [symbol] [symbol] . The TX/RX beam codebooks consists of card ( [symbol] _{TX}) and card ( [symbol] _{RX}) distinct analog beams, respectively. The RX user nodes are considered to employ fully digital beamforming, since the number of the user antennas is typically much smaller than at the FD massive MIMO BS.

### A. DL and Radar Reflected Signals

A 5G NR subframe-based DL signaling operation is assumed for the considered multi-user FD massive MIMO ISAC system. In each subframe, the BS transmits mm Wave 5G NR OFDM waveforms to the DL users comprising Q OFDM symbols with P active subcarriers and Δf subcarrier spacing. In addition to the DL communication, these OFDM symbols are reflected by multiple radar targets and received at the BS RX, which is utilized for tracking targets across subframes.

To enable multi-user MIMO communication, each subcarrier of the DL waveform contains L parallel data streams for each of the U DL users such that UL≤N_{RF}. In the BaseBand (BB), the uth user's unit frequency-domain symbol vector at [symbol] [symbol] [symbol] at the pth subcarrier of qth OFDM symbol is precoded using digital beamforming matrix [symbol] [symbol] [symbol] =1, . . . , U. Furthermore, the precoded signals are processed by the analog BF and the transmitted frequency-domain symbol vector [symbol] [symbol] [symbol] at the antenna elements can be written as

$$\begin{matrix}{x}_{p , q} & {=}^{△} {V}_{RF} [ {V}_{BB , 1} , … {V}_{BB , U} ] [ {s}_{p , q , 1}^{T} , … , {s}_{p , q , U}^{T} ] \\ & = {V}_{RF} {V}_{{BB}^{S} p , q}\end{matrix} , \qquad ( 1 )$$

where [symbol] [symbol] [symbol] [symbol] [symbol] and

$${s}_{p , q} {=}^{△} {[ {s}_{p , q , 1}^{T} , … , {s}_{p , q , U}^{T} ]}^{T} ∈ {ℂ}^{UL} .$$

The DL transmission is power limited such that [symbol] [symbol] , where P_{b} represents the maximum transmission power at node b.

For the integrated sensing operation, K radar targets/scatters randomly distributed within the communication/sensing environment are assumed. Each of the K targets is associated with a DoA/DoA [symbol] and a range δₖ from the BS node corresponding to a respective delay [symbol] [symbol] [symbol] , where c represents the speed of light. It is to be noted that direction of departure and arrival of radar targets are identical since a monostatic radar setup is considered assuming relatively far away targets and small TX-RX array separation. These radar targets reflect the DL transmitted signal [symbol] , which is received at the RX of the FD BS node b. The radar RX signal [symbol] [symbol] [symbol] comprising reflected and SI signals is expressed as

$${y}_{p , q} {=}^{△} {\sum }_{k = 1}^{K} {α}_{k} {e}^{- j 2 {πτ}_{k} p Δ f} {a}_{M} ( {θ}_{k} ) {a}_{N}^{H} ( {θ}_{k} ) {x}_{p , q} + {H}_{SI} {x}_{p , q} + {n}_{p , q} , \qquad ( 2 )$$

where

$${n}_{p , q} \sim 𝒞𝒩 ( 0 , {σ}_{b}^{2} {I}_{M} )$$

and αₖ∈ [symbol] denote the receiver noise vector with covariance

$${σ}_{b}^{2}$$

and the reflection coefficient of the kth radar target, respectively. The propagation delay τₖ induces the phase shift [symbol] across subcarriers. Here, the ith element of the ULA response vector [symbol] [symbol] [symbol] with N antenna elements and any DoA θ is expressed as

$${[ {a}_{N} ( θ ) ]}_{i} {=}^{△} \frac{1}{\sqrt{N}} {e}^{- j \frac{2 π}{λ} ( i - 1 ) d sin ( θ )} , \qquad ( 3 )$$

where λ and d are the signal wavelength and the inter-antenna element distance, respectively.

Here, [symbol] [symbol] [symbol] is the Line-of-Sight (LoS) SI channel path between the TX and RX antenna arrays of the BS node b, which can be modeled as

$${[ {H}_{SI} ]}_{( m , n )} {=}^{△} \frac{ρ}{{τ}_{m , n}} {e}^{- j \frac{2 π}{λ} {τ}_{m , n}} , \qquad ( 4 )$$

where, ρ represents the power normalization constant such that

$$𝔼 \{ {‖ {[ {H}_{SI} ]}_{( m , n )} ‖}_{F}^{2} \} = MN .$$

Here, r_{m,n} denotes the distance between mth RX and nth TX antenna elements at the BS node, which depends on the transmit and receive array geometry.

The received signal at the node b RX is processed by the RX analog combiner W_{RF}, which is followed by analog and digital cancellation to suppress the LOS SI signal below the noise floor. In the RX BB of the BS, the frequency-domain radar reflected symbol vector [symbol] [symbol] [symbol] can be expressed as

$${\tilde{y}}_{p , q} {=}^{△} {W}_{RF}^{H} {\sum }_{k = 1}^{K} {α}_{k} {e}^{- j 2 {πτ}_{k} p Δ f} {a}_{M} ( {θ}_{k} ) {a}_{N}^{H} ( {θ}_{k} ) {x}_{p , q} + ( {\tilde{H}}_{SI} + C + D ) {V}_{{BB}^{s} p , q} + {W}_{RF}^{H} {n}_{p , q} , \qquad ( 5 )$$

where [symbol] and D [symbol] represent the low complexity analog and digital SI cancellers, respectively. After the analog cancellation, the residual SI signal satisfy the RX RF saturation constraint, i.e., [symbol] , where ρ_{b} represents the saturation level of RX RF chains at the BS node b. It is to be noted that the low complexity analog canceller C suppressing the LOS SI components is designed following the similar structure in G. C. Alexandropoulos et al., “Full duplex hybrid A/D beamforming with reduced complexity multi-tap analog cancellation,” in Proc. IEEE SPAWC, Atlanta, USA, May 2020. Here,

$${\tilde{H}}_{SI} {=}^{△} {W}_{RF}^{H} {H}_{SI} {V}_{RF}$$

represents the effective LOS SI channel after analog TX/RX beamforming.

For the multi-user DL communication, U out of K scatterers are assumed to contribute to the DL channels from the BS node b to the U users. For each scatter, θᵤ, ∀ᵤ=1, . . . , U represents the DoD, while ϕᵤ denotes the DoA at the user node. The received DL signal vector at the uth user [symbol] is expressed as

$${r}_{p , q , u} {=}^{△} {β}_{u} {a}_{L} ( {ϕ}_{u} ) {a}_{N}^{H} ( {θ}_{u} ) {x}_{p , q} + {z}_{p , q , u} = {H}_{DL , u} {x}_{p , q} + {z}_{p , q , u} , \qquad ( 6 )$$

where [symbol] and

$${z}_{p , q , u} \sim 𝒞𝒩 ( 0 , {σ}_{u}^{2} {I}_{L} )$$

represent reflection coefficient of uth scatter and the noise floor at RX node u with covariance

$${σ}_{u}^{2} ,$$

respectively. Here,

$${H}_{DL \text{?}} {=}^{Δ} {β}_{\text{?}} {a}_{L} ( {ϕ}_{\text{?}} ) {a}_{N}^{H} ( {θ}_{\text{?}} )$$

$$\text{?} \text{indicates text missing or illegible when filed}$$

represents the DL channel from BS node to uth user.

### III. FD-Enabled Multi-Target Tracking

In this section, the proposed FD ISAC DL data transmission and multiple radar target estimation and tracking operation are presented. The received reflected signals at the BS node RX are utilized for estimation and tracking.

### A. Radar Targets/Scatterers Evolution

A 5G NR subframe-based DL communication system is assumed, where each radio subframe of Tₛ duration contains Q OFDM symbols with P subcarriers. The radar targets' and communication scatters' parameters are considered to remain constant for one subframe, while the parameters of the successive subframes are temporarily correlated. For any consecutive (i-1) and ith subframes, the evolution of radar DoA components is expressed as

$${θ}_{k} [ i ] {=}^{Δ} {θ}_{k} [ i - 1 ] + {Δθ}_{k} , ∀ k = 1 , … , K , \qquad ( 7 )$$

where Δθₖ depends on the velocity of the kth radar target and the subframe duration Tₛ. For simplicity, we assume that all the radar targets are moving with a constant velocity υ in a circular direction from the BS, hence,

$${Δθ}_{k} {=}^{Δ} arctan ( \frac{\text{?} {T}_{\text{?}}}{{δ}_{\text{?}}} ) .$$

$$\text{?} \text{indicates text missing or illegible when filed}$$

For brevity, the radar targets' complex-valued reflection coefficients αₖ and DL channels complex path gains βᵤ, ∀u are assumed to change randomly between consecutive time slots. This disclosure proposes tracking only the radar targets' DoA components for each time subframe. The estimation of all complex path gains and reflection coefficients is left for future investigation.

### B. ISAC Multi-Target Tracking Operation Protocol

The proposed FD ISAC protocol for DL data transmission and multiple radar target estimation and tracking is illustrated in FIG. 2A, where the DL channel is dedicated for data transmission to the users while the UL is accessed at the BS node to receive the reflected signals from radar targets simultaneously. The procedures of FD ISAC transmission are described as follows:

(1) At any (i-1)th time subframe, the DL signal reflected by the radar targets is received by the FD BS node b enabled by reduced complexity massive MIMO FD analog and digital canceller.

(2) Utilizing the received signal after SI suppression, the DoAs of all K targets during (i-1)th time subframe \hat{θ}ₖ[i-1], ∀k are estimated at the BS node b along with their range \hat{δ}ₖ, ∀k.

(3) During the DL data transmission to U users at ith time subframe, the estimated DoAs \hat{θ}ₖ[i-1] are used to choose appropriate digital beamformer V_{BB}[i] and TX/RX phase shifter configurations V_{RF}[i] and W_{RF}[i] to assure maximized DL rate and satisfy RF saturation level constraint at the BS node b.

In FIG. 2B, a conventional HD ISAC system is illustrated, where, contrary to the FD case, a portion of the subframe is dedicated for DL transmission while the rest is utilized for radar target detection.

### C. Multiple Radar Targets' DoA Estimation

At the (i-1)th time subframe, the received reflected signal \tilde{y}_{p,q}[i-1] is utilized to estimate the DoAs of K radar targets employing MUltiple Signal Classification (MUSIC) algorithm. First, the sample covariance matrix is calculated across all subcarriers and OFDM symbols of (i-1)th subframe as

$${\hat{R}}_{\text{?}} [ i - 1 ] {=}^{Δ} \frac{1}{PQ} {\sum }_{q = 0}^{Q - 1} {\sum }_{p = 0}^{P - 1} {\tilde{y}}_{p , q} [ i - 1 ] {\tilde{y}}_{p , q}^{\text{?}} [ i - 1 ] . \qquad ( 8 )$$

$$\text{?} \text{indicates text missing or illegible when filed}$$

Now the eigenvalue decomposition of the estimated sample covariance matrix \hat{R}_{b}[i-1] as

$${\hat{R}}_{\text{?}} [ i - 1 ] {=}^{Δ} U diag \{ {η}_{1} , {η}_{2} , … , {η}_{{M}_{RF}} \} {U}^{\text{?}} , \qquad ( 9 )$$

$$\text{?} \text{indicates text missing or illegible when filed}$$

where [symbol] are the eigenvalues in the descending order and U∈ [symbol] [symbol] represents the eigenvector matrix. The matrix U is partitioned into signal and noise subspace as U=[Uₛ|Uₙ], where Uₙ∈ [symbol] [symbol] and Uₙ∈ [symbol] [symbol] contains the noise and signal subspace eigenvectors. Now, the DoAs of K radar targets is estimated finding K peaks of the MUSIC spectrum formulated as

$${P}_{MUSIC} ( θ ) {=}^{Δ} \frac{1}{{a}_{M}^{H} ( θ ) {W}_{RF} [ i - 1 ] {U}_{\text{?}} {U}_{n}^{H} {W}_{RF}^{H} [ i - 1 ] {a}_{M} ( θ )} . \qquad ( 10 )$$

$$\text{?} \text{indicates text missing or illegible when filed}$$

The K peaks of P_{MUSIC}(θ) correspond to the K estimated DoAs θₖ[i-1], ∀k.

### D. Multiple Radar Targets' Range Estimation

Now, the range of K radar targets at the (i-1)th subframe is estimated. As mentioned before, the range of radar targets δₖ, ∀k corresponds to propagation delay τₖ, ∀k. Here, we obtain the estimated delay at (i-1)th subframe τₖ[i-1], ∀k from which respective range can be achieved. Utilizing the estimated DoAs \hat{θ}ₖ[i-1] and the BB transmit signal vector x_{p,q}[i-1], a reference signal is formulated in the radar target direction as

$${g}_{p , q} {=}^{Δ} {a}_{M} ( {{θ}^{\text{?}}}_{k} [ i - 1 ] ) {a}_{N}^{H} ( {{θ}^{\text{?}}}_{k} [ i - 1 ] ) {x}_{p , q} [ i - 1 ] .$$

$$\text{?} \text{indicates text missing or illegible when filed}$$

Now, a quotient is formulated across all RX antennas which includes the propagation delay impact in the direction of \hat{θ}ₖ[i-1] as

$${z}_{p , q} {=}^{Δ} \frac{1}{M} {\sum }_{m = 1}^{M} \frac{{[ {W}_{RF} [ i - 1 ] {\tilde{y}}_{p , q} [ i - 1 ] ]}_{m}}{{[ {g}_{p , q} [ i - 1 ] ]}_{m}} , ∀ p , q \qquad ( 11 )$$

The quotient [symbol] is utilized to formulate a likelihood function as

$$A ( n ) {=}^{Δ} {\sum }_{q = 0}^{Q - 1} {\sum }_{p = 0}^{P - 1} {z}_{p , q} {e}^{j 2 π \frac{\text{?}}{\text{?}}} ,$$

$$\text{?} \text{indicates text missing or illegible when filed}$$

where n=0, . . . , P-1 is the quantized delay parameters. Now, the best quantized delay is found that maximizes the likelihood function norm as follows

$${n}^{\text{?}} {=}^{Δ} {arg max}_{\text{?}} {\vert A ( n ) \vert}^{2} . \qquad ( 12 )$$

$$\text{?} \text{indicates text missing or illegible when filed}$$

Therefore, estimated delay of the kth target at (i-1)th subframe is expressed as

$${\hat{τ}}_{k} [ i - 1 ] {=}^{Δ} \frac{{n}^{\text{?}}}{P Δ f}$$

$$\text{?} \text{indicates text missing or illegible when filed}$$

and the range is formulated as

$${\hat{δ}}_{k} [ i - 1 ] {=}^{Δ} \frac{{\hat{τ}}_{k} [ i - 1 ] c}{2} .$$

The DoA and delay estimation technique is utilized for any subframe to track the radar targets distributed within the communication environment.

### IV. Proposed Optimization Framework

In this section, the focus is on the joint design of the A/D beamformers V_{BB}[i], V_{RF}[i], W_{RF}[i] and SI cancellation matrices C[i], D[i] at the ith subframe to optimize multi-user MIMO communication and multiple radar target tracking performance.

The proposed FD ISAC optimization framework maximizes the Signal-to-Noise-Ratio (SNR) to the DL users as well as all the radar targets to optimize both tracking and DL communication. Utilizing the estimated DoAs of (i-1)th subframe θₖ[i-1], ∀k, the SNR in all the radar targets' direction at the ith subframe can be expressed as,

$${\hat{Γ}}_{R} [ i ] {=}^{Δ} {‖ {W}_{RF}^{H} [ i ] {\sum }_{k = 1}^{K} {a}_{M} ( {\hat{θ}}_{k} [ i - 1 ] ) {a}_{N}^{H} ( {\hat{θ}}_{k} [ i - 1 ] ) {V}_{RF} [ i ] \times {V}_{BB} [ i ] ‖}^{2} {\hat{\sum }}_{b}^{- 1} [ i ] , \qquad ( 13 )$$

where

$${\hat{\sum }}_{b} [ i ] = {‖ ( {{H}^{\text{?}}}_{ST} [ i ] + C [ i ] + D [ i ] ) {V}_{BB} [ i ] ‖}^{2} + {‖ {W}_{RF} [ i ] ‖}^{2} {σ}_{b}^{2}$$

$$\text{?} \text{indicates text missing or illegible when filed}$$

represents the residual SI plus noise covariance. With the objective to maximize DL rate, the sum of U DL users' SNR is devised as

$${\hat{Γ}}_{DL} [ i ] {=}^{Δ} {\sum }_{u = 1}^{U} {‖ {\hat{H}}_{DL , u} [ i - 1 ] {V}_{RF} [ i ] {V}_{BB} [ i ] ‖}^{2} {σ}_{u}^{- 2} . \qquad ( 14 )$$

The optimization problem is formulated maximizing both SNR in the Radar target direction and DL users as

$$\begin{matrix}𝒪𝒫 : {max}_{{{V}_{RF} [ i ] , {V}_{BB} [ i ] , {W}_{RF} [ i ]}_{C [ i ] , D [ i ]}} {\hat{Γ}}_{R} [ i ] + {\hat{Γ}}_{DL} [ i ] \\ \text{s.t.} {‖ {[ ( {\hat{\tilde{H}}}_{SI} [ i ] + C [ i ] ) {V}_{BB} [ i ] ]}_{( m , i )} ‖}^{2} \leq {ρ}_{b} , ∀ m = 1 , \text{} … , {M}_{RF} , 𝔼 \{ ‖ {V}_{RF} [ i ] {V}_{BB} [ i ] {‖}^{2} \} \leq {P}_{b} , {w}_{m} [ i ] ∈ {𝔽}_{RX} , ∀ m and {v}_{n} [ i ] ∈ {𝔽}_{TX} , ∀ n = 1 , … , {N}_{RF}\end{matrix} \qquad ( 15 )$$

An alternating optimization approach is employed to solve this non-convex problem suboptimally. First, using the estimated DoAs \hat{θ}ₖ[i-1] at any (i-1)th subframe, the analog TX/RX BFs is found that maximizes the signal power toward all radar direction while minimizing the SI channel impact at the RX of BS node b. Utilizing the analog BFs, the N_{C}≤N_{RF}M_{RF} taps analog canceller is found using a procedure similar to that of Example 2 of the present disclosure. Finally, the multi-user digital precoder V_{BB} is designed using block diagonalization such that it maximizes the SNR of the DL users while minimizing the inter-user interference and suppressing the residual SI at node b. The proposed solution for (15) is summarized in Algorithm 1.

Algorithm 1 Multi-user FD-Based ISAC Optimization

Input: Ĥ_{SI}[i − 1], Ĥ_{DL,u}[i − 1], N_{C}, P_{b} and \hat{θ}ₖ[i − 1] ∀k.
Output: V_{RF}[i], V_{BB}[i], W_{RF}[i], C[i], and D[i].

| | |
|---|---|
| 1: | $Set {\hat{H}}_{R} [ i ] = {\sum }_{k = 1}^{K} {a}_{M} ( {\hat{θ}}_{k} [ i - 1 ] ) {a}_{N}^{H} ( {\hat{θ}}_{k} [ i - 1 ] ) .$ |
| 2: | $Set {V}_{RF} [ i ] {=}^{△} {arg max}_{{v}_{n} ∈ {𝔽}_{TX} , {∀}_{n}} {‖ {\hat{H}}_{R} [ i ] V ‖}^{2} .$ |
| 3: | $Set {W}_{RF} [ i ] {=}^{△} {arg max}_{{w}_{m} ∈ {𝔽}_{RX} , {∀}_{m}} \frac{{‖ {W}^{H} {\hat{H}}_{R} [ i ] {V}_{RF} [ i ] ‖}^{2}}{{‖ {W}^{H} {\hat{H}}_{m} [ i - 1 ] {V}_{RF} [ i ] ‖}^{2}} .$ |
| 4: | $Set {{H}^{\hat{\sim}}}_{SI} [ i ] = {W}_{RF}^{H} [ i ] {\hat{H}}_{SI} [ i - 1 ] {V}_{RF} [ i ] , {{H}^{\hat{\sim}}}_{DL , u} [ i ] = {\hat{H}}_{DL , u} [ i - 1 ] {V}_{RF} [ i ] , ∀ u .$ |
| 5: | Set C[i], D[i]as in[18, Alg. 2], and B as the N_{RF} right- |
| | singular vectors of ( [symbol] \hat{\tilde{H}}_{IS}[i] + C[i]). |
| 6: | for α = N_{RF}, N_{RF} − 1, .... , 2 do |
| 7: | $Set F = {[ B ]}_{( 1 , {N}_{RF} - α + 1 : {N}_{RF} )} , {H}_{eff , u} = {\hat{\tilde{H}}}_{DL , u} [ i ] F , ∀ u .$ |
| 8: | Set Ëᵤ ∈ [symbol] ^{N}^{_{RF}}^{×L} as the null space of effective DL channel with uth user removed |
| | ${\tilde{H}}_{eff , u} {=}^{△} [ {H}_{eff , 1}^{T} , … , {H}_{eff , u - 1}^{T} , {H}_{eff , u + 1}^{T} , … , {H}_{eff , U}^{T} ] .$ |
| 9: | Set Eᵤ as the right singular vectors of H_{eff,u}Ëᵤ. |
| 10: | $Set {G}_{u} = \sqrt{{P}_{b} / U} {\ddot{E}}_{u} {E}_{u} as the optimum block ‐ diagonalized precoder$ |
| | for uth user given P_{b}. |
| 11: | Obtain digital precoder G = [G₁, ... , G_{U}] repeating |
| | steps 8-10 for all U users, |
| 12: | $if {‖ {[ ( {\hat{\tilde{H}}}_{SI} [ i ] + C [ i ] ) FG ]}_{( m , 1 )} ‖}^{2} \leq {p}_{b} , ∀ m , then$ |
| 13: | Output V_{BB}[i] = FG and stop the algorithm. |
| 14: | else |
| 15: | Output C[i] does not meet the residual SI constraint. |
| 16: | end if |
| 17: | end for |

### V. Numerical Results

In this section, the numerical evaluation of the proposed FD massive MIMO multi-

user communication and multi-target tracking system is presented through extensive waveform simulation.

### A. Simulation Parameters

Following the FD massive MIMO architecture in FIG. 1, a 128×128 FD massive MIMO BS node b with N_{RF}=M_{RF}=8 TX/RX RF chains is considered. Since the BS node employs a partially-connected beamforming structure, each TX/RX RF chain is connected to a ULA of N_{A}=M_{A}=16 antenna elements via phase shifters. Both TX/RX phase shifter configurations (analog beams) are chosen from 5-bit Discrete Fourier Transform (DFT) codebooks. The multi-user MIMO communication is realized by U=2 users, each with L=2 RX antennas. A mmWave communication of 28 GHz frequency with 5G NR OFDM waveforms of 100 MHz BandWidth (BW) is considered. Additional 5G NR waveform and system-level parameters are provided in Table. I. The DL channels from BS to the user are assumed to be clustered mmWave channels with 100 dB pathloss. The LOS SI channel is simulated as (4) with 5 mm TX-RX antenna array separation. The RX noise floors at all nodes are considered −90 dBm, which results in −30 dBm of RF saturation level at node b for effective dynamic range of 60 dB considering 14-bit ADCs.

TABLE I
WAVEFORM AND SYSTEM LEVEL PARAMETERS

| Parameter | Value | | Parameter | Value | |
|---|---|---|---|---|---|
| Carrier Frequency | 28 | GHz | Transmit Power | 10:30 | dBm |
| Bandwidth | 100 | MHz | RX Noise Floor | −90 | dBm |
| Subframe Duration, Tₛ | 1 | ms | ADC Bits | 14 | bits |
| OFDM Symbols, Q | 14 | | PAPR | 10 | dB |
| Data Subcarriers, P | 792 | | Dynamic Range | 60 | dB |
| Subcarrier Spacing, Δf | 120 | KHz | RF Saturation | −30 | dBm |

Within the sensing/communication environment, K=4 radar targets/scatters are considered out of which U=2 contributes to the DL channel. Each K target is associated with a DoA θₖ∈[−60° 60°], ∀k and a maximum range of 80 m. Twenty (20) radio subframes were simulated in each simulation run to evaluate the radar target estimation performance.

### B. Multiple Radar Target Sensing Performance

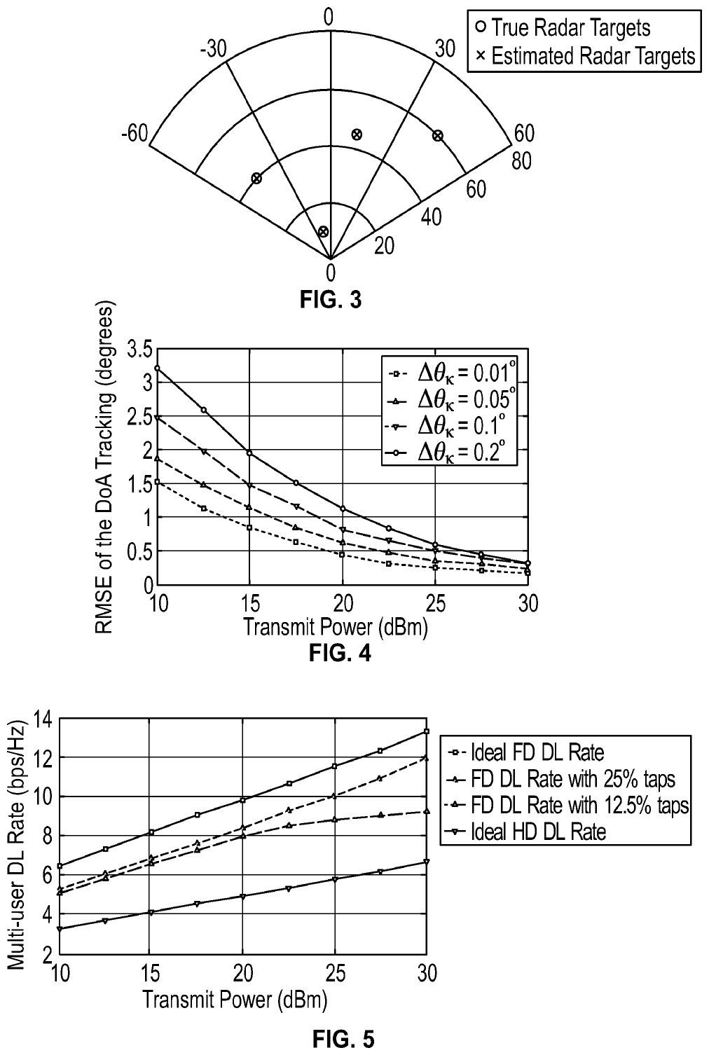

In FIG. 3, the sensing performance of the proposed multi-user FD ISAC system is illustrated with a 128×128 massive MIMO node transmitting DL signal with a transmit power of 30 dBm. The estimated DoA and range of each radar target are depicted in the figure. It is evident that the proposed FD ISAC approach successfully estimates the DoA and range of all the K=4 radar targets. The precise radar targets' DoA and range detection performance are due to the proposed target delay estimation associated with the high-resolution MUSIC approach.

### C. Multi-Target Tracking Performance

In FIG. 4, the Root Mean Square Error (RMSE) of the DoA tracking in degrees is plotted for all the radar targets across 20 5G NR radio subframes with different DoA evolution Δθₖ=[0.01° 0.05° 0.1° 0.2°] between consecutive subframes. For a range of 20 m, an angle evolution of 0.2° corresponds to a velocity of 250 km/h for radar targets. Therefore, the proposed FD ISAC approach is capable of tracking multiple radar targets moving at very high speed. For a moderate transmit power of 20 dBm, the proposed approach provides less than 1° RMSE for most of the DoA evolution cases. However, the RMSE of DoA tracking for all different Δθₖ cases is around 0.25° for 30 dBm transmit power exhibiting precise target tracking performance.

### D. Multi-User DL Data Rate

The multi-user DL rate performance of the proposed FD ISAC system is depicted in FIG. 5 for different transmit powers, where the massive MIMO node b is communicating with 2 DL users. The proposed FD ISAC approach provides the DL rate within 1 bps/Hz of the ideal FD rate up to 20 dBm transmit power. However, with the increased impact of SI at high transmit powers, the FD ISAC system with 12.5% (N=8) SI cancellation taps exhibits rate reduction compared to the ideal FD case. In contrast, the proposed approach with 25% taps provides comparable performance for all different transmit power values. Furthermore, the proposed FD ISAC system offers a superior multi-user DL rate compared to the ideal HD ISAC approach for all transmit power cases.

### VI. Conclusion

In this example, a multi-user FD ISAC framework is presented with an FD massive MIMO node simultaneously transmitting towards multiple DL users and estimating DoA as well as range of radar targets utilizing the reflected DL waveforms. A radar target tracking and DL transmission protocol across multiple communication subframes was designed. Utilizing a limited complexity analog SI cancellation for FD massive MIMO system, a joint design of the A/D beamformer and analog SI cancellation was presented that maximizes both radar target tracking and multi-user DL rate performance. The performance results considering a mmWave channel model exhibited the high precision DoA and range estimation of multiple radar targets while providing maximized multi-user DL rate.

### EXAMPLE 2

### Integrated Sensing and Communication With Millimeter Wave Full Duplex Hybrid Beamforming

Integrated Sensing and Communication (ISAC) has attracted substantial attention in recent years for spectral efficiency improvement, enabling hardware and spectrum sharing for simultaneous sensing and signaling operations. In-band Full Duplex (FD) is being considered as a key enabling technology for ISAC applications due to its simultaneous transmission and reception capability. An FD-based ISAC system is presented operating at millimeter Wave (mmWave) frequencies, where a massive Multiple-Input Multiple-Output (MIMO) Base Station (BS) node employing hybrid Analog and Digital (A/D) beamforming is communicating with a DownLink (DL) multi-antenna user and the same waveform is utilized at the BS receiver for sensing the radar targets in its coverage environment. A sensing algorithm has been developed that is capable of estimating Direction of Arrival (DoA), range, and relative velocity of the radar targets. A joint optimization framework for designing the A/D transmit and receive beamformers as well as the Self-Interference (SI) cancellation is presented with the objective to maximize the achievable DL rate and the accuracy of the radar target sensing performance. The simulation results, considering fifth Generation (5G) Orthogonal Frequency Division Multiplexing (OFDM) waveforms, verify this approach's high precision in estimating DoA, range, and velocity of multiple radar targets, while maximizing the DL communication rate.

### I. Introduction

Integrated Sensing and Communication (ISAC) is an emerging concept for future wireless networks, where the previously competing sensing and communication operations are jointly optimized in the same hardware platform using a unified signal processing framework. Recently, Full Duplex (FD) massive Multiple-Input Multiple-Output (MIMO) communications have been considered a key enabler for ISAC applications due to their simultaneous UpLink (UL) and DownLink (DL) transmission capability within the entire frequency band. Furthermore, FD massive MIMO ISAC applications at millimeter Wave (mmWave) frequencies have the potential to provide high-capacity communication links while simultaneously achieving high-resolution sensing, e.g., Direction of Arrival (DoA), range, and relative speed of radar targets/scatterers.

The performance of the FD ISAC systems relies on the in-band Self-Interference (SI) signal suppression capability that stems from the Transmitter (TX) to the Receiver (RX) side during FD operation. Recently, SI cancellation was achieved for the FD massive MIMO systems operating at mmWave, utilizing a combination of propagation domain isolation, analog domain suppression, and digital SI cancellation techniques. To alleviate the hardware cost in mmWave massive MIMO transceivers, hybrid Analog and Digital (A/D) beamformers are usually employed, where large-scale antenna arrays are usually connected to a small number of Radio Frequency (RF) chains via analog preprocessing networks comprised of phase shifters. Such systems require appropriate beam selection for analog TX/RX beamformers, chosen from predefined codebooks, to maximize DL rate and sensing accuracy. Moreover, in the envisioned FD ISAC with massive MIMO radios, the transmit waveform will be utilized for both DL data transmission and sensing of the radar targets. Therefore, a joint design of the A/D beamformers and SI cancellation along with sensing techniques is required for maximizing the performance of FD ISAC systems.

Very recently, joint radar communication and sensing frameworks, leveraging FD operation, were considered for single-antenna systems, where both communication and radar waveforms were optimized for sensing performance. The FD ISAC operation was proposed for mmWave frequency bands considering a massive MIMO FD Base Station (BS), where the signal power is maximized in the radar target direction, while maintaining a threshold DL rate performance. Although the considered FD ISAC approach estimated the DoA two radar targets, the range was only calculated for one target due to its disassociated DoA and range estimation technique.

This Example discloses a novel FD massive MIMO ISAC system operating at mmWave frequencies and realizing hybrid A/D beamforming, where Orthogonal Frequency Division Multiplexing (OFDM) waveforms are utilized for both DL communication and radar target sensing. Unlike state-of-the-art works, an ISAC optimization framework is devised that is capable of estimating the DoA, range, and relative velocity of multiple radar targets, while maximizing the DL communication rate. The numerical results, considering the fifth Generation (5G) New Radio (NR) OFDM waveform, verify the high sensing accuracy and the increased communication rate of the proposed optimization design.

### II. System and Signal Models

We consider an FD ISAC system comprising of an FD mmWave massive MIMO Base Station (BS) node b equipped with Nb TX and Mb RX antenna elements communicating in the DL direction with an RX User Equipment (UE) node u with Mu antenna elements, while the reflected DL signal is utilized to detect radar targets/scatterers randomly distributed within the communication/sensing environment at the RX of BS node b, as depicted in FIG. 6. To reduce the number of RF chains and phase shifters, the BS node b employs a partially-connected Hybrid Beam Forming (HBF) structure with A/D TX and RX beamformers, where each of the

$${N}_{b}^{RF} and {M}_{b}^{RF}$$

TX/RX RF chains is connected to Uniform Linear Arrays (ULA) of

$${N}_{b}^{A} and {M}_{b}^{A}$$

antenna elements, respectively, via phase shifters. Therefore, it holds

$${N}_{b} = {N}_{b}^{A} {N}_{b}^{RF} and {M}_{b} = {M}_{b}^{A} {M}_{b}^{RF}$$

for total number of TX and RX antennas, respectively, at the BS node b. Since the size of the antenna array at the UE node u is typically much smaller than at the FD massive MIMO BS b, it is assumed that the UE adopts a fully digital beamforming structure.

It is assumed that BS node b transmits mmWave OFDM waveforms in the DL direction containing Q OFDM symbols with P active subcarriers. In the BaseBand (BB), the unit power frequency-domain symbol vector [symbol] [symbol] [symbol] at the pth subcarrier of qth OFDM symbol is precoded using digital beamforming matrix

$${V}_{b}^{BB} ∈ {ℂ}^{{N}_{b}^{RF} \times {\overline{d}}_{b}} , where {d}_{b} \leq min \{ {N}_{b}^{RF} , {M}_{u} \} .$$

Following the BB precoder, the DL signal is processed by the analog beamformer

$${V}_{b}^{RF} ∈ {ℂ}^{{N}_{b} \times {\overline{N}}_{b}^{RF}}$$

containing the configurations of the phase shifters as follows:

$${V}_{b}^{RF} {=}^{△} [ \begin{matrix}{v}_{1} & {0}_{{N}_{b}^{A} \times 1} & … & {0}_{{N}_{b}^{A} \times 1} \\ {0}_{{N}_{b}^{A} \times 1} & {v}_{2} & … & {0}_{{N}_{b}^{A} \times 1} \\ ⋮ & ⋮ & ⋱ & ⋮ \\ {0}_{{N}_{b}^{A} \times 1} & {0}_{{N}_{b}^{A} \times 1} & … & {0}_{{N}_{b}^{( RF )}}\end{matrix} ] \qquad ( 1 )$$

The elements of each vᵢ are assumed to have constant magnitude, i.e.,

$${\vert {[ {v}_{i} ]}_{n} \vert}^{2} = 1 / {N}_{b}^{A} ∀ n = 1 , 2 , … , {N}_{b}^{A} .$$

It is also assumed that

$${v}_{i} ∈ {𝔽}_{TX} ∀ i = 1 , 2 , … , {N}_{b}^{RF} ,$$

which means that all analog TX precoding vectors belong in a predefined beam codebook [symbol] _{TX} including card ( [symbol] _{TX}) distinct vectors (or analog beams). Applying both A/D beamforming, the TX frequency-domain symbols at the antenna elements are expressed as

$${x}_{p , q} {=}^{△} {V}_{b}^{RF} {V}_{b}^{BB} {s}_{p , q} \qquad ( 2 )$$

where [symbol] [symbol] [symbol] . The signal transmissions at node b are power limited according to

$$𝔼 \{ {‖ {V}_{b}^{RF} {V}_{b}^{BB} {s}_{p , q} ‖}^{2} \} \leq {P}_{b} .$$

### A. Radar Signal Reception Model

For sensing operation, a collection of K radar targets/scatterers are considered that are randomly distributed within the communication/sensing environment and are to be detected by the BS node b. All the K targets reflect DL signal back to the RX of the BS node, while only a subset of them (L out of K) contributes to the DL communication scattering paths between the BS node b and the RX UE node u. The purpose of the sensing operation is to estimate the DoA, range, and relative velocity of each radar target.

It is considered that the DoAs of the K targets are defined as [symbol] , while the distance and the relative speed of kth target correspond to a delay τₖ and a Doppler shift [symbol] , respectively. Enabled by FD, the received signal [symbol] [symbol] [symbol] at the RX of the BS node b combining the SI and the reflected signal by the Radar targets is expressed as

$${y}_{p , q} {=}^{△} {\sum }_{k = 1}^{K} {α}_{k} {e}^{j 2 π ( {qT}_{k} {f}_{D , k} - p {τ}_{k} △ f )} {a}_{{M}_{0}} ( {θ}_{k} ) {a}_{{N}_{b}}^{H} ( {θ}_{k} ) {x}_{p , q} + {H}_{b , b} {x}_{p , q} + {n}_{p , q} , \qquad ( 3 )$$

where [symbol] and [symbol] and

$${n}_{p , q} ∼ 𝒞𝒩 ( 0 , {σ}_{b}^{2} {I}_{{M}_{b}} )$$

represent the reflection coefficient of the kth radar target and the receiver noise floor, respectively. Here, Δf and Tₛ [symbol] 1/Δf+T_{cp} denote the subcarrier spacing and the total OFDM symbol duration (including the cyclic prefix). The propagation delay causes the phase shift [symbol] across subcarriers, while the Doppler shift contributes a row-wise oscillation across different OFDM symbols. Considering ULA, the steering vector a_{Nb} (θ) for N_{b} antenna elements and any DoA θ is formulated as

$${a}_{{M}_{b}} ( θ ) {=}^{△} {\frac{1}{\sqrt{{N}_{b}}} [ 1 , {e}^{j \frac{2 π}{λ} d sin ( θ )} , … , {e}^{j \frac{2 π}{λ} ( {N}_{b} - 1 ) d sin ( θ )} ]}^{T} , \qquad ( 4 )$$

where λ is the propagation signal wavelength and d denotes the distance between adjacent antenna elements. Here, [symbol] [symbol] [symbol] is the SI channel path at the BS node b, which is modeled as a Rician fading mmWave Channel (see eq. (9) in K. Satyanarayana et al., “Hybrid beamforming design for full-duplex millimeter wave communication,” IEEE TRANS. VEH. TECHNOL., vol. 68, no. 2, pp. 1394-1404 December 2018.).

The received signal at the node b RX is first processed by the RF combiner

$$\text{?} ∈ \text{?} ,$$

$$\text{?} \text{indicates text missing or illegible when filed}$$

where the structure of the combiner is formulated similarly as (1). Here, the analog RX combining vectors belong in a predefined beam codebook [symbol] _{RX} including card ( [symbol] _{RX}) distinct vectors. After RF combination and A/D SI cancellation, the received signal is expressed as

$${\tilde{y}}_{p , q} {=}^{Δ} {( {W}_{b}^{RF} )}^{H} {\sum }_{k = 1}^{K} {α}_{k} \text{?} {a}_{{M}_{b}} ( {θ}_{k} ) {a}_{{N}_{b}}^{H} ( {θ}_{k} ) {x}_{p , q} + ( {\tilde{H}}_{b , b} + {C}_{b} + {D}_{b} ) {V}_{b}^{BB} {s}_{p , q} + {( {W}_{b}^{RF} )}^{H} {n}_{p , q} , \qquad ( 5 )$$

$$\text{?} \text{indicates text missing or illegible when filed}$$

where

$${\tilde{H}}_{b , b} {=}^{Δ} {( {W}_{b}^{RF} )}^{H} {H}_{b , b} {V}_{b}^{RF}$$

is the effective SI channel after analog TX/RX beamforming. Here, C_{b} and D_{b} represent the analog and digital SI cancellation, respectively, that are designed following the structure presented in G. C. Alexandropoulos, M. A. Islam, and B. Smida, “Full duplex hybrid A/D beamforming with reduced complexity multi-tap analog cancellation,” PROC. IEEE SPAWC, Atlanta, USA, May 2020.

### B. DI. Signal Reception Model

As mentioned above, L out of K scatterers contributes to the DL channel [symbol] [symbol] [symbol] . As the principal focus of the disclosure is to estimate Radar target parameters, we ignore the delay and Doppler shift parameters for the DL channel. Now, the received DL signal vector [symbol] [symbol] [symbol] at the UE RX is expressed as

$$\begin{matrix}{r}_{p , q} {=}^{Δ} {W}_{u}^{H} ( {\sum }_{ℓ = 1}^{L} {β}_{ℓ} \text{?} ( {θ}_{ℓ} ) \text{?} ( {θ}_{ℓ} ) {x}_{p , q} + {z}_{p , q} ) \\ = {W}_{u}^{H} ( {H}_{u , b} {x}_{p , q} + {z}_{p , q} )\end{matrix} , \qquad ( 6 )$$

$$\text{?} \text{indicates text missing or illegible when filed}$$

where [symbol] [symbol] and

$${z}_{p , q} ∼ 𝒞𝒩 ( 0 , {σ}_{u}^{2} \text{?} )$$

$$\text{?} \text{indicates text missing or illegible when filed}$$

represent the complex reflection coefficient of Eth scatter path and the noise floor at RX node u, respectively.

The achievable DL rate of the FD ISAC system can be expressed as

$${ℛ}_{DL} {=}^{Δ} {log}_{2} ( det ( \text{?} + \text{?} {V}_{b}^{RF} {{V}_{b}^{BB} ( {V}_{b}^{RF} {V}_{b}^{BB} )}^{H} \times {H}_{u , b}^{H} {{W}_{u} ( {W}_{u}^{H} \text{?} )}^{- 1} ) ) , \qquad ( 7 ) .$$

$$\text{?} \text{indicates text missing or illegible when filed}$$

### III. DoA, Delay, and Doppler Shift Estimation

In this section, the estimations of the DoA, delay and Doppler shift parameters of the Radar targets are presented, which are realized by the BS's RX using the reflected signals.

### A. Radar Target DoA Estimation

For DoA estimation, the MUltiple SIgnal Classification (MUSIC) algorithm is deployed; other DoA estimation techniques can be used as well. First, the covariance matrix of the radar target reflected signal is estimated. Across all subcarriers and OFDM symbols of the communication slot, the covariance matrix

$${R}_{b} ∈ \text{?}$$

$$\text{?} \text{indicates text missing or illegible when filed}$$

can be estimated as

$${R}_{b} {=}^{Δ} 𝔼 \{ {\tilde{y}}_{p , q} {\tilde{y}}_{p , q}^{H} \} , {\hat{R}}_{b} {=}^{Δ} \frac{1}{PQ} {\sum }_{q = 0}^{Q - 1} {\sum }_{p = 0}^{P - 1} {\tilde{y}}_{p , q} {\tilde{y}}_{p , q}^{H} . \qquad ( 8 )$$

By taking the eigenvalue decomposition of the estimated sample covariance matrix \hat{R}_{b}, it is deduced that:

$${\hat{R}}_{b} {=}^{Δ} U diag \{ {η}_{1} , {η}_{2} , … , {η}_{{M}_{b}} \} {U}^{H} , \qquad ( 9 )$$

where

$${η}_{1} \geq {η}_{2} \geq … \geq {η}_{{M}_{b}^{RF}}$$

are the eigenvalues of \hat{R}_{b} and

$$U ∈ \text{?}$$

$$\text{?} \text{indicates text missing or illegible when filed}$$

contains their corresponding eigenvectors. Since the disclosure is focused on estimating the DoAs of K radar targets, the matrix U can be partitioned as U=[Uₛ|Uₙ], where the columns in

$${U}_{n} ∈ \text{?}$$

$$\text{?} \text{indicates text missing or illegible when filed}$$

are the eigenvectors spanning the noise subspace and

$${U}_{s} ∈ {ℂ}^{{M}_{b}^{RF} \times K}$$

contains the signal space eigenvectors. The MUSIC spectrum for the considered HBF architecture can be thus formulated as:

$$S ( θ ) {=}^{Δ} {( \text{?} ( θ ) {W}_{b}^{RF} \text{?} {( {W}_{b}^{RF} )}^{H} \text{?} ( θ ) )}^{- 1} \qquad ( 10 )$$

$$\text{?} \text{indicates text missing or illegible when filed}$$

whose K peaks correspond to the K estimated DoAs [symbol] ∀k.

### B. Delay and Doppler Shift Estimation

The next step is to estimate the delay and Doppler shift parameters associated with the K estimated DoAs. Using the estimate DoA [symbol] and the known transmit signal x_{p,q}, a reference signal in the DoA direction is formulated as

$${g}_{p , q} {=}^{Δ} {a}_{{M}_{b}} ( {\hat{θ}}_{k} ) {a}_{{N}_{b}}^{H} ( {\hat{θ}}_{k} ) {x}_{p , q} . \qquad ( 11 )$$

Now, the received signal \tilde{y}_{p,q} is utilized to derive the quotient averaged across all RX antennas that includes the effect of delay and Doppler shift in the direction of [symbol] as

$${z}_{p , q} {=}^{Δ} \frac{1}{{M}_{b}} {\sum }_{i = 1}^{{M}_{b}} {[ {W}_{b}^{RF} {\tilde{y}}_{p , q} ]}_{i} {/ [ {g}_{p , q} ]}_{i} , ∀ p , q . \qquad ( 12 )$$

To estimate \tilde{τ}ₖ and Ĵ_{D,k} the likelihood function is formulated:

$$A ( n , m ) {=}^{Δ} {\sum }_{p = 0}^{P - 1} ( {\sum }_{q = 0}^{Q - 1} {z}_{p , q} {e}^{- j 2 π \frac{\text{?}}{Q}} ) {e}^{j 2 π \frac{\text{?}}{\text{?}}} , \qquad ( 13 )$$

$$\text{?} \text{indicates text missing or illegible when filed}$$

where n=0, . . . , P-1 and m=−Q/2, . . . , Q/2−1. Finally, the best quantized delay and Doppler shift that maximizes the likelihood function norm are found. The delay and Doppler shift estimation procedure is provided in Algorithm 1.

Algorithm 1 Delay and Doppler Shift Estimation

$\text{Input:} {x}_{p , q} , {\tilde{y}}_{p , q} , ∀ p , q , {W}_{b}^{RF} , and {\hat{θ}}_{k} ∀ k .$
Output: \hat{T}ₖ, \hat{f}_{D,k}, ∀ k.

| | |
|---|---|
| 1: | $Set n = 0 , … , P - 1 and m = - \frac{Q}{2} , … , \frac{Q}{2} - 1.$ |
| 2: | for k = 1, 2, ... , K do |
| 3: | $Set {g}_{p , q} {=}^{△} {a}_{{M}_{b}} ( {\hat{θ}}_{k} ) {a}_{{N}_{b}}^{H} ( {\hat{θ}}_{k} ) {x}_{p , q} .$ |
| 4: | $Set {z}_{p , q} {=}^{△} \frac{1}{{M}_{b}} {\sum }_{i = 1}^{{M}_{b}} {[ {W}_{b}^{RF} {\tilde{y}}_{p , q} ]}_{i} {/ [ {g}_{p , q} ]}_{i} , ∀ p , q .$ |
| 5: | $Set A ( n , m ) {=}^{△} {\sum }_{p = 0}^{P - 1} ( {\sum }_{q = 0}^{Q - 1} {z}_{p , q} {e}^{- j 2 π \frac{qm}{Q}} ) {e}^{j 2 π \frac{pn}{P}} .$ |
| 6: | $Set ( {n}^{*} , {m}^{*} ) = {arg max}_{n , m} {\vert A ( n , m ) \vert}^{2} .$ |
| 7: | $Set the estimated delay {\hat{τ}}_{k} = \frac{{n}^{*}}{P Δ f} .$ |
| 8: | $Set the Doppler frequency of k th target {\hat{f}}_{D , k} = \frac{{m}^{*}}{{QT}_{e}} .$ |
| 9: | end for |

### IV. Proposed ISAC Optimization Framework

In this section, a joint optimization framework is presented deriving A/D beamformers and SI cancellation matrices with the objective to maximize the DL rate and the radar estimation accuracy.

A time division duplexing communication protocol was considered, where the DoAs estimated in one communication time slot is utilized to derive the beamformers and SI cancellation matrices for the successive slot. To optimize the DL rate and radar target parameter estimation accuracy, it is proposed to maximize the SNR in both the DL and radar target direction.

Given the estimated DoAs \hat{θ}ₖ, the SNR in the direction of all radar targets can be written as

$${\hat{Γ}}_{\text{?}} {=}^{Δ} {‖ {( {W}_{n}^{RF} )}^{H} {\sum }_{b = 1}^{K} {a}_{{M}_{\text{?}}} ( {\hat{θ}}_{k} ) {a}_{{N}_{\text{?}}}^{H} ( {\hat{θ}}_{k} ) {V}_{b}^{RF} {V}_{b}^{BB} ‖}^{2} {\sum }_{b}^{- 1} , \qquad ( 14 )$$

$$\text{?} \text{indicates text missing or illegible when filed}$$

where

$${\sum }_{b} = {‖ ( {{\tilde{H}}^{⌢}}_{b , b} + {C}_{b} + {D}_{b} ) {V}_{b}^{BB} ‖}^{2} + {‖ {W}_{b}^{BF} ‖}^{2} {σ}_{b}^{2}$$

is the interference plus noise covariance matrix at the RX of node b. Similarly, the estimated DL SNR is expressed as

$${\hat{Γ}}_{DL} = {‖ {W}_{u}^{H} {\sum }_{ℓ = 1}^{L} {a}_{{M}_{u}} ( {θ}_{ℓ} ) {a}_{{N}_{b}}^{H} ( {θ}_{ℓ} ) {V}_{b}^{RF} {V}_{b}^{BB} ‖}^{2} {\sum }_{u}^{- 1} , \qquad ( 15 )$$

where

$${\sum }_{u} {‖ {W}_{u} ‖}^{2} {σ}_{u}^{2}$$

is the noise covariance matrix at the RX node u.

The optimization problem to maximize the Radar target and DL SNR can be written as

$$\begin{matrix}𝒪𝒫 : {{max}_{{V}_{b}^{RF} , {V}_{u}^{BB} , {W}_{b}^{RF}}}_{{C}_{b} , {D}_{b} , {W}_{u}} {\hat{Γ}}_{Bada} + {\hat{Γ}}_{DL} \\ s . t . {‖ {[ ( {{\tilde{H}}^{⌢}}_{b , b} + {C}_{b} ) {V}_{b}^{BB} ]}_{( j , \text{?} )} ‖}^{2} \leq {λ}_{b} , ∀ j = 1 , … , {M}_{b}^{RF} , \\ 𝔼 \{ {‖ {V}_{b}^{RF} {V}_{b}^{BB} ‖}^{2} \} \leq {P}_{b} , \\ {w}_{j} ∈ {𝔽}_{RX} ∀ j and {v}_{n} ∈ {𝔽}_{TX} ∀ n = 1 , 2 , … , {N}_{b}^{( RF )}\end{matrix} \qquad ( 16 )$$

$$\text{?} \text{indicates text missing or illegible when filed}$$

The optimization problem in (16) is a non-convex problem with coupling variables, hence, quite difficult to tackle. In this work, the optimization problem is solved suboptimally using alternating optimization, leaving other possibilities for future work.

First, using the estimated DoAs, a virtual channel is formulated in the radar target direction as

$${\hat{H}}_{R} {=}^{Δ} {\sum }_{b = 1}^{K} {a}_{{M}_{b}} ( {\hat{θ}}_{k} ) {a}_{{N}_{b}}^{H} ( {\hat{θ}}_{k} ) .$$

Now to maximize the radar SNR, the TX analog beams are found solving the following suboptimization problem:

$$𝒪𝒫 1 : {V}_{b}^{RF} {=}^{Δ} {arg max}_{{v}_{j} ∈ {𝔽}_{TX}} {‖ {\hat{H}}_{R} {V}_{b}^{RF} ‖}^{2} \qquad ( 17 )$$

The solution of [symbol] 1 requires a simple search through the beam codebook [symbol] _{TX}. Using the TX analog beamformer

$${V}_{b}^{RF} ,$$

the analog combiner is derived solving the suboptimization problem [symbol] 1, where the radar SNR is maximized while simultaneously suppressing SI signal as follows:

$$𝒪𝒫 2 : {W}_{b}^{RF} {=}^{Δ} {arg max}_{{w}_{j} ∈ {P}_{TX}} \frac{{‖ {( {W}_{b}^{RF} )}^{H} {\hat{H}}_{R} {V}_{b}^{RF} ‖}^{2}}{{‖ {( {W}_{b}^{RF} )}^{H} {\hat{H}}_{b , b} {V}_{b}^{RF} ‖}^{2}} \qquad ( 18 )$$

Similar to [symbol] 1, the solution of [symbol] 2 requires a simple search through the available beam codebook [symbol] _{RX}. Given the analog SI cancellation taps

$$N \leq {N}_{b}^{RF} {M}_{b}^{RF}$$

and the analog TX/RX beamformer at the BS, a similar procedure to is followed as set forth in G. C. Alexandropoulos, M. A. Islam, and B. Smida, “Full duplex hybrid A/D beamforming with reduced complexity multi-tap analog cancellation,” PROC. IEEE SPAWC, Atlanta, USA, May 2020. The aim is to find the digital beamforming matrix

$${V}_{b}^{BB}$$

and the SI cancellation matrices maximizing the DL rate and suppressing the SI signal power below the RF saturation level of λ_{b}. The latter will ensure proper reception of the Radar target reflected signal. The solution of the present disclosure for the optimization problem (16) is summarized in Algorithm 2.

Algorithm 2 FD ISAC Optimization

Input: H_{b,b}, N, P; and \hat{θ}ₖ ∀ k.
$\text{Input:} {\hat{H}}_{b , b} , N , {P}_{b} and {\hat{θ}}_{k} ∀ k .$

| | |
|---|---|
| 1: | $Set {\tilde{H}}_{R} {=}^{△} {\sum }_{k = 1}^{K} {a}_{{M}_{b}} ( {\hat{θ}}_{k} ) {a}_{{N}_{b}}^{H} ( {\hat{θ}}_{k} ) .$ |
| 2: | $Set {\hat{H}}_{u , b} {=}^{△} {\sum }_{l = 1}^{L} {a}_{{M}_{n}} ( {\hat{θ}}_{l} ) {a}_{{N}_{b}}^{H} ( {\hat{θ}}_{l} ) .$ |
| 3: | Set Wᵤ as the d_{b} left singular vectors of Ĥ_{u,b} correspond- |
| | ing to the singular values in descending order. |
| 4: | $Set {V}_{b}^{RF} {=}^{△} {arg max}_{{v}_{j} ∈ {𝔽}_{TX}} {‖ {\hat{H}}_{R} {V}_{b}^{RF} ‖}^{2} .$ |
| 5: | $Set {W}_{b}^{RF} {=}^{△} {arg max}_{{w}_{j} ∈ {𝔽}_{TX}} \frac{{‖ {( {W}_{b}^{RF} )}^{H} {\hat{H}}_{R} {V}_{b}^{RF} ‖}^{2}}{{‖ {( {W}_{b}^{RF} )}^{M} {\hat{H}}_{b , b} {V}_{b}^{RF} ‖}^{2}} .$ |
| 6: | $Set {{H}^{\hat{\sim}}}_{b , b} = {( {W}_{b}^{RF} )}^{H} {\hat{H}}_{b , b} {V}_{b}^{RF} and {{H}^{\hat{\sim}}}_{u , b} = {\hat{H}}_{u , b} {V}_{b}^{RF} .$ |
| 7: | $Set {C}_{b} = [ \begin{matrix}- {[ {{H}^{\hat{\sim}}}_{b , b} ]}_{1 , L \frac{N}{{M}_{b}^{RF}}} & {0}_{1 , ( {N}_{b}^{RF} - \frac{N}{{M}_{b}^{RF}} , {N}_{b}^{RF} )}\end{matrix} ] and$ |
| | ${D}_{b} = - ( {\hat{\tilde{H}}}_{b , b} + {C}_{b} ) .$ |
| 8: | $Obtain B with the {N}_{b}^{RF} right - singular vectors of ( {{H}^{\hat{\sim}}}_{b , b} +$ |
| | C_{b}) corresponding to the singular values in descending |
| | order |
| 9: | $for α = {N}_{b}^{RF} , {N}_{b}^{RF} - 1 , … , 2 do$ |
| 10: | $Set F = {[ B ]}_{( 1 , {N}_{b}^{RF} - α + 1 : {N}_{b}^{RF} )} .$ |
| 11: | Set G as the optimum precoding for the effective DL |
| | $MIMO channel {\hat{\tilde{H}}}_{u , b} F given {P}_{b} .$ |
| 12: | $if {‖ {[ ( {{H}^{\hat{\sim}}}_{b , b} + {C}_{b} ) FG ]}_{( j , 1 )} ‖}^{2} \leq {λ}_{b} , ∀ j = 1 , … , {M}_{b}^{RF} , then$ |
| 13: | $Output {V}_{b}^{BB} = FG and stop the algorithm .$ |
| 14: | else |
| 15: | Output that the C_{b} realization does not meet the |
| | residual SI constraint. |
| 16: | end if |
| 17: | end for |

### V. Numerical Results

In this section, present numerical results are presented for the radar sensing and DL

rate performance of the proposed FD massive MIMO ISAC system operating at mmWave frequencies.

### A. Simulation Parameters

An extensive waveform simulation is performed following the FD massive MIMO architecture illustrated in FIG. 6 when operating at mmWave frequencies, where a 128×128 FD massive MIMO node b is communicating in the DL direction with 4 antenna RX UE node u. The BS node b employs

$${N}_{b}^{RF} = {M}_{b}^{RF} = 8 TX / RX RF$$

chains with each of them connected to a ULA of

$${N}_{b}^{A} = {M}_{b}^{A} = 16$$

antenna elements via phase shifters. The communication is performed using mmWave frequency of 28 GHz and a 5G NR OFDM waveform with 100 MHz BandWidth (BW) and Δf=120 KHz subcarrier spacing. According to the 5G NR specifications, there are 66 Physical Resource Blocks (PRBs) resulting in P=792 active subcarriers and Q=14 OFDM symbols in each communication slot. Total OFDM symbol duration is defined as Tₛ=8.92 μs. A radio subframe of 1 ms is considered for DL communication. The RX noise floors at all nodes were assumed to be −90 dBm for 100 MHz BW OFDM signal. To this end, the RXs have an effective dynamic range of 60 dB provided by 14-bit Analog-to-Digital Converters (ADC) for a Peak-to-Average-Power-Ratio (PAPR) of 10 dB. Therefore, the residual SI power after analog SI cancellation at the input of each RX RF chain has to be below −30 dBm to avoid signal saturation. The pathloss of the clustered DL channel is assumed to be 100 dB, whereas the SI channels are modeled as Rician fading channels with a k-factor of 35 dB and pathloss 40 dB. For the BS analog TX/RX beamformer, a 5-bit beam codebook based on the Discrete Fourier Transform (DFT) matrix is considered. One thousand (1000) independent Monte Carlo simulation runs were used to calculate the Radar sensing and DL rate performance.

### B. Radar Target Parameters

K=6 radar targets randomly distributed in the sensing/communication environment with DoAs θₖ∈[−90° 90°], ∀k were considered. For communication scatters, L=2 out of K=6 targets are chosen randomly. For each of the radar targets, the range and relative velocity is selected randomly with a maximum range of 80 m and maximum velocity of 100 km/h.

### C. Radar Target Sensing Performance

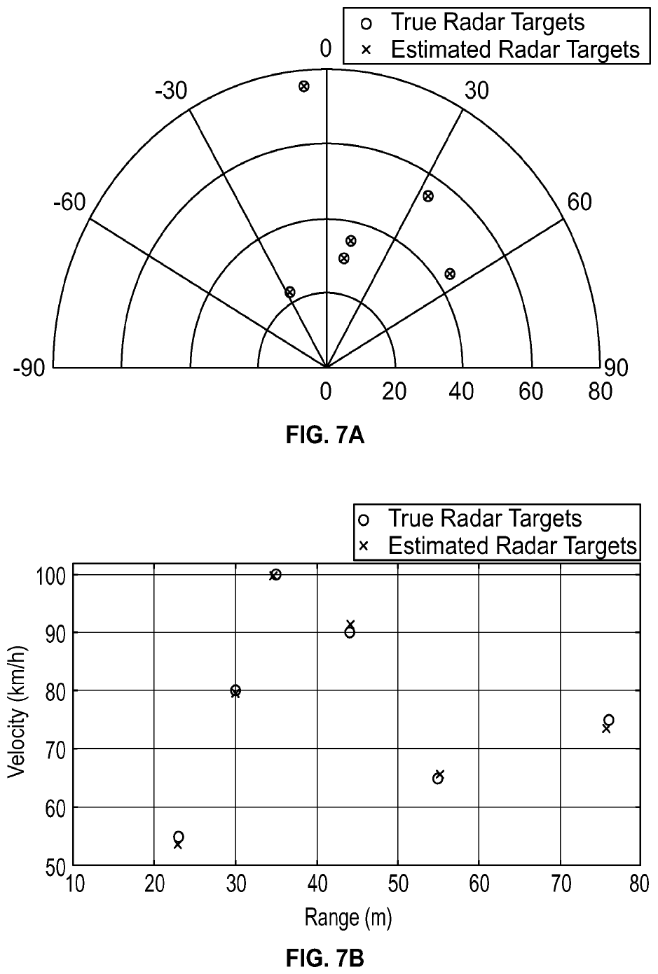

In FIGS. 7A-B, the sensing performance of the proposed FD ISAC system is depicted with a 128×128 massive MIMO node transmitting DL signal with a transmit power of 30 dBm. The DoA and range estimation is plotted in contrast to the true target parameters in FIG. 7A, where it is evident that the proposed FD ISAC system can detect all 6 targets successfully with high precision. Even for really close target (10° and 12°) with only 2° angle and less than 5 m range difference, the estimation performance is highly accurate. The superior sensing performance is provided by the proposed associated delay estimation approach with high-resolution MUSIC DoA estimation unlike previous FD ISAC work, where range estimation for such close targets was not possible. In FIG. 7B, the relative velocity is plotted with respect to the range estimation for 30 dBm DL transmit power. The figure shows that the proposed FD ISAC system is capable of estimating the relative velocity of all 6 targets with less than 1.5% estimation error.

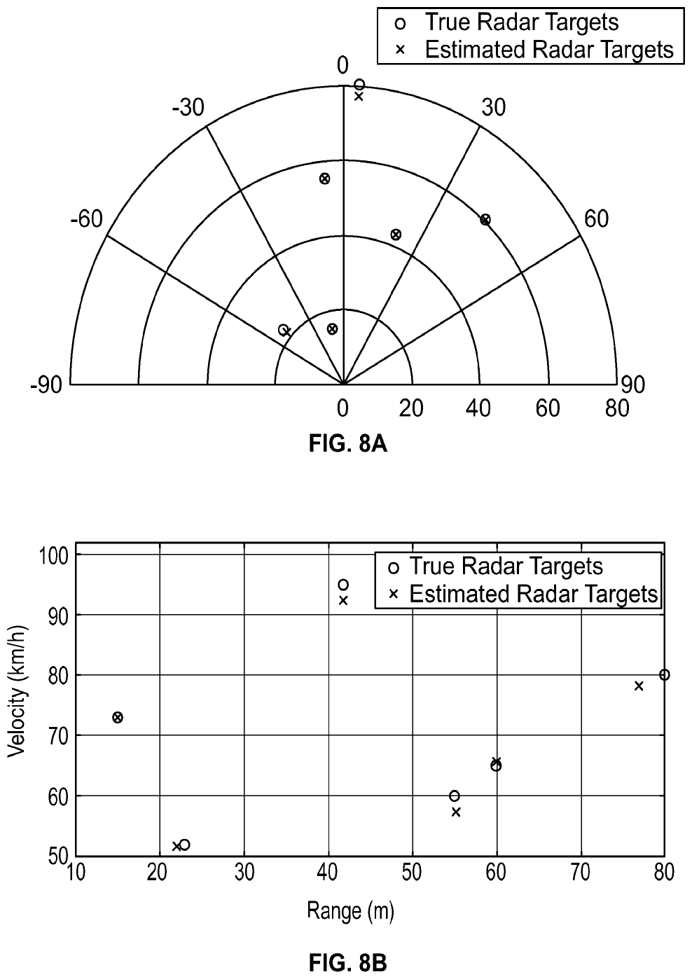

In FIGS. 8A-B, radar target sensing performance of the proposed FD ISAC system is presented for 10 dBm DL transmit power. It is evident from FIG. 8A that the DoA estimation is almost accurate even at a low transmit power of 10 dBm. However, for the target at 3°, the estimated range is around 3 m away from the actual value of 80 m. This is due to the low transmit power and higher path loss of the furthest target. In FIG. 8B, the relative velocity estimation is showcased, where the proposed approach achieved sensing performance with less than 5% estimation error for a low transmit power of 10 dBm.

The DL rate performance of the proposed FD ISAC system with a 128×128 massive MIMO BS node transmitting to a 4 antenna UE RX node is depicted in FIG. 9 with respect to transmit power. It is evident from the figure that the proposed FD ISAC approach is capable of providing DL rate very close (1.5 bps/Hz) to the ideal rate in addition to the high radar sensing performance at the RX of BS node for N=16 (25%) analog SI cancellation taps at the FD massive MIMO node. For even smaller hardware complexity (12.5%) taps, the DL rate performance is comparable up to 20 dB transmit power. However, as transmit power increases the impact of SI signal worsens, for DL transmit power of 30 dBm, the FD ISAC system is capable of providing 75% of the ideal DL rate with only N=8 SI cancellation taps.

### VI. Conclusion

In this Example, an FD-based ISAC optimization framework is presented, where an FD massive MIMO BS node is transmitting DL signals and concurrently performing radar target sensing utilizing the reflected signals. A DoA, delay, and Doppler shift estimation algorithm was devised for multiple radar target sensing considering hybrid A/D beamforming at the BS node. Adopting a limited complexity analog SI cancellation architecture, a joint design of the A/D beamformer and SI cancellation is presented that maximizes the DL rate together with the target sensing performance. The performance results for a mmWave channel model demonstrated the high precision DoA, range, velocity estimation of multiple radar targets while providing maximized DL rate. In future work, the proposed FD ISAC approach will be considered for sensing and communication demanding practical applications, such as autonomous vehicles and flight control systems.

Clause 1. An FD-based ISAC optimization system, including a Full Duplex massive Multiple-input and Multiple-output (MIMO) BS node configured to transmit Down Link (DL) signals from a waveform received at the node and concurrently therewith perform radar target sensing utilizing reflected signals of the waveform.

Clause 2. An ISAC optimization framework and system including a processor operatively connected thereto for analyzing an estimate of a Direction of Arrival (DoA), a range, and a relative velocity of each of a number of radar targets while optimizing the DL communication rate.

Clause 3. A system according to clause 1, the FD ISAC system further including an FD mm Wave massive MIMO Base Station (BS) node b equipped with an Nb TX and an Mb RX antenna element configured for bidirectional communication in the DL direction with an RX User Equipment (UE) node u. A system according to clause 1, the reflected DL signals received in the system and analyzed to detect radar targets/scatterers randomly distributed within the communication/sensing environment.

Clause 4. The system according to clause 1, wherein a DL transmit power in the range of 30 dBm, a DoA and a range estimation are generated by a processor operatively connected to the system,

Clause 5. The system according to clause 1, wherein a target range and relative velocity estimation is generated with a DL transmit power of 10 dBm, including both a DoA and a range estimation, and a range and a relative velocity estimation.

Clause 6. The system according to clause 1 or 2, wherein a Vehicular side link (Communication and sensing for vehicular networks) is generated and transmitted using the range estimation generated by the processor of the system.

Clause 7. The system according to clause 1 or 2, configured in at least one of an In Communication Base station (5G &/or 6G), a UAV's, and an Autonomous Vehicles, and configured to generate the radar target estimation result from the “Downlink” signal.

Clause 8. An ISAC optimization system and framework, comprising a Full Duplex massive Multiple-input and Multiple-output (MIMO) BS node configured to transmit Down Link (DL) signals and concurrently performing radar target sensing with a processor operatively connected thereto based on the reflected signals received at the node.

Clause 9. A Full Duplex (FD) based Integrated Sensing and Communication (ISAC) system operating at millimeter Wave (mmWave) frequencies including a node and processor operatively connected thereto and configured to generate simultaneous radar target sensing and DownLink (DL) data transmission signals, wherein the simultaneous transmission and reception capability of the FD system can perform high-resolution long-range parameter estimation of multiple radar targets while maximizing the DL data rate.

Clause 10. The FD ISAC system including a MIMO Base Station (BS) node comprising hybrid beamforming and multi-antenna DL Receiver (RX) components, the FD ISAC MIMO node configured to transmit a 5G OFDM waveform to the DL RX components processed by the analog and digital beamformers, and radar targets distributed in the communication-sensing environment and configured to reflect the 5G OFDM waveform;

the reflected 5G OFDM waveform received at the RX of the FD ISAC node and processed by the analog beamformer, wherein after sufficient Self-Interference (SI) cancellation, the reflected waveform is analyzed by a processor of the system to perform radar target sensing.

Clause 11. The system according to one of clauses 1-2 and 9-11, further including a sensing algorithm stored as an executable file in a processor directly or indirectly connected to the system, the sensing algorithm causing the processor to perform steps from which a Direction of Arrival (DoA) estimate, a range, and a relative velocity of the radar targets is generated, and by deploying a high-resolution multiple signal classification approach for the DoA estimation, the sensing algorithm performs low-complexity range and velocity estimation of radar targets.

Clause 12. A joint optimization framework and system for analog and digital beamformers wherein an SI cancellation is generated at an FD ISAC node to maximize DL rates of the system and the accuracy of radar target sensing performance from the DL signals of the system.

Clause 13. A system according to clause 12, the system further configured to estimate radar targets at a high DL data rate.

1. A Full Duplex-based ISAC optimization system, comprising:
a Full Duplex (FD) massive Multiple-input and Multiple-output (MIMO) Base Station (BS) node configured to operate at mmWave frequencies and having a plurality of transmitter antenna elements (N_{A} TX) and a plurality of receiver antenna elements (M_{A} RX) configured to communicate in a DownLink (DL) direction with a plurality of mobile users that each have a plurality of antenna receiver elements (L), wherein the plurality of RX antenna elements of the FD massive MIMO BS node are configured to receive DL signals reflected by a plurality of radar targets; and
at least one processor configured to detect the plurality of radar targets randomly distributed within a communication environment based on the plurality of reflected DL signals, wherein the at least one processor is further configured to determine an estimation of (i) a Direction of Arrival (DoA), (ii) a range, and (iii) a relative velocity for each of the plurality of radar targets while optimizing a DL communication rate to the plurality of mobile users.

2. The FD-based ISAC optimization system of claim 1, wherein the FD massive MIMO BS node is configured to transmit mmWave Orthogonal Frequency Division Multiplexing (OFDM) waveforms in the DL direction containing Q OFDM symbols with P active subcarriers.

3. The FD-based ISAC optimization system of claim 1, further comprising:
a hybrid beam-forming structure (HBF) comprising a plurality of TX radio-frequency (RF) chains and a plurality of RX RF chains that are operatively connected to uniform linear arrays (ULAs) of the plurality of antenna elements N_{A} TX and M_{A} RX via analog phase shifters that are contained in analog beamformers V_{RF} and W_{RF}, respectively.

4. The FD-based ISAC optimization system of claim 3, further comprising:
a digital beamforming matrix V_{BB} operatively connected to the analog beamformer V_{RF} and the processor, wherein the digital beam forming matrix V_{BB} is configured to precode a unit power frequency-domain symbol vector at a pth subcarrier of a qth OFDM symbol in a BaseBand (BB).

5. The FD-based ISAC optimization system of claim 3, further comprising:
a Self-Interference (SI) canceller operatively connected to the HBF configured for both analog and digital cancellation.

6. The FD-based ISAC optimization system of claim 1, further comprising:
a DL channel dedicated to data transmission to the plurality of mobile users; and
an UpLink (UL) channel configured to simultaneously receive the reflected DL signals from the plurality of radar targets.

7. The FD-based ISAC optimization system of claim 1, wherein the FD massive MIMO BS node and the processor are coupled to an In-Communication 5G BS, an In-Communication 6G BS, a UAV, or an Autonomous Vehicle.

8. A method for using the FD-based ISAC optimization system of claim 1, the method comprising:
transmitting, via the plurality of TX antenna elements of the FD massive MIMO BS node, mmWave Orthogonal Frequency Division Multiplexing (OFDM) waveforms in the DL direction to the plurality of radar targets;
receiving, via the plurality of RX antenna elements of the FD massive MIMO BS node, DL signals reflected by the plurality of radar targets; and
estimating, via the processor, the DoA, the range, and the relative velocity for each of the DL signals reflected by the plurality of radar targets;
wherein the transmitted mm Wave OFDM waveform is used for both DL data transmission and for sensing of the plurality of the radar targets via the estimations for the DoA, the range, and the relative velocity of the plurality of radar targets.

9. The method of claim 8, wherein the mmWave OFDM waveforms contain Q OFDM symbols with P active subcarriers, the method further comprising:
before transmitting the mmWave OFDM waveforms in the DL direction to the plurality of radar targets:
precoding, via digital beamforming matrix V_{BB}, a unit power frequency-domain symbol vector at a pth subcarrier of a qth OFDM symbol in a DL signal; and
after precoding the unit power frequency-domain symbol vector, processing, via an analog beamformer V_{RF}, the DL signal.

10. The method of claim 8, further comprising:
after the reflected DL signals are received:
processing the reflected DL signals, via an analog beamformer W_{RF}, to achieve RF combination; and
then performing analog and digital Self-Interference (SI) cancellation on the reflected DL signals, via at least one SI canceller, to thereby suppress the Line-of-Sight (LoS) SI signal below a noise floor.

11. The method of claim 10, wherein after the analog SI cancellation, a residual SI signal satisfies an RX RF saturation constraint.

12. The method of claim 8, wherein transmitting the mm Wave OFDM waveforms in the DL direction to the plurality of mobile users occurs in subframes of Tₛ duration.

13. The method of claim 12, wherein after SI cancellation is performed on the received signals, estimating the DoA and the range for each of the DL signals reflected by the plurality of radar targets is performed at an (i-1)th time subframe, the method further comprising:
during DL data transmission to the plurality of radar targets at an ith time subframe, determining, via the processor, an appropriate digital beam former V_{BB}[i], a TX phase shifter configuration V_{RF}[i], and an RX phase shifter configuration W_{RF}[i] based on the estimated DoAs for each of the plurality of radar targets.

14. The method of claim 13, wherein determining, via the processor, the appropriate digital beam former V_{BB}[i], the TX phase shifter configuration V_{RF}[i], and the RX phase shifter configuration W_{RF}[i] is further determined to maximize signal power toward all radar directions and to minimize SI channel impact at the plurality of RX antenna elements of the FD massive MIMO BS node.

15. The method of claim 12, wherein the plurality of radar targets are tracked across the subframes.

16. The method of claim 8, wherein a digital beamforming matrix V_{BB} is configured using block diagonalization to maximize the Signal-to-Noise-Ratio of the plurality of radar targets, to minimize interference between the plurality of radar targets, and to suppress a residual SI at the FD massive MIMO BS node.

17. The method of claim 8, further comprising:
maximizing the Signal-to-Noise-Ratio, via the processor, for transmitted signals in both the DL direction and a radar target direction.

18. The method of claim 8, wherein transmitting mmWave OFDM waveforms in the DL direction to the plurality of mobile users is conducted with a transmission power ranging from 10 dBm to 30 dBm.

19. The method of claim 8, wherein the mmWave OFDM waveforms comprise 5G OFDM waveforms.

20. The method of claim 8, further comprising:
generating, via the processor, a vehicular side link based on the estimated range of one of the plurality of radar targets; and
transmitting, via at least one of the plurality of TX antenna elements of the FD massive MIMO BS node, the vehicular side link to the particular radar target that corresponds to the subject estimated range.
